(19) United States
(12) Patent Application Publication
(10) Pub. No.: US 2024/0092245 A1
(43) Pub. Date: Mar. 21, 2024

(54) VEHICLE SHELVING CONVEYANCE AND STORAGE SYSTEMS AND METHODS

(71) Applicant: Rivian IP Holdings, LLC, Irvine, CA (US)

(72) Inventors: Philip Samuel Tompkins, Irvine, CA (US); Avsharn Singh Bhambra, Irvine, CA (US); George Corder, Romulus, MI (US); Daniel Adam Beverley, Mission Viejo, MI (US); Aditya Desai, Irvine, CA (US); Alex Cheng-Chi Yang, Redwood City, CA (US)

(21) Appl. No.: 18/341,073

(22) Filed: Jun. 26, 2023

Related U.S. Application Data
(60) Provisional application No. 63/375,996, filed on Sep. 16, 2022.

(51) Int. Cl. B60P 1/54

(52) U.S. Cl. CPC B60P 1/5495

(57) ABSTRACT

A vehicle and components thereof are provided. The vehicle can include an apparatus having a shelving module, a post, and a mechanism.

### CROSS-REFERENCE TO RELATED PATENT APPLICATIONS

This application claims the benefit of and priority to U.S. Provisional Patent Application No. 63/375,996 filed Sep. 16, 2022. The entirety of which is incorporated by reference herein.

### INTRODUCTION

Vehicles can have batteries and the batteries can provide power to the components of the vehicle.

### SUMMARY

This disclosure is generally related to at least one vehicle and at least one apparatus. The apparatus can be included in or associated with the vehicle. The apparatus can include at least one of a shelving module, a lift device or a mounting module. The vehicle can include a power source and an inverter. The inverter can convert power provided by the power source. For example, the inverter can convert Alternating Current (AC) to Direct Current (DC) or the convertor can convert DC to AC. The inverter can provide the converted power to the apparatus or a component associated with the apparatus.

The shelving module can be coupled with the vehicle. For example, the shelving module can be attached to a wall of the vehicle. The shelving module can be removed from the wall (e.g., the shelving module can be decoupled) and then the shelving module can be recoupled or reattached to the vehicle. For example, the shelving module can be coupled with the vehicle in a first position and then shelving module can be decoupled from the vehicle (e.g., the shelving module is no longer attached to the vehicle in the first position). The shelving module can be recoupled to the vehicle. The shelving module can be recoupled in the first position (e.g., the position that the shelving module was previously coupled with the vehicle) or a second position (e.g., a position that is different that the first position). The shelving module can hold at least one component. For example, the shelving module can hold a power drill.

The lift device can be coupled with the vehicle. For example, the lift device can be attached to the floor of the vehicle. The lift device can be stowed in a position that is within the vehicle or the lift device can be deployed to a position that is external to the vehicle. The lift device can have at least one stowed configuration or orientation and the stowed configuration can decrease the overall area or volume that the lift device occupies. At least one part, component or portion of the lift device can rotate, extend, adjust or otherwise be located outside of the vehicle. The lift device in at least one of the stowed position or the deployed position can lift, grab, adjust or otherwise move at least one object. The lift device can make contact with or couple with the object and the lift device can move the object from a first location to a second location. For example, the lift device can couple with a vehicle tire and the lift device can move the tire from a location that is external to the vehicle to a location that is within the vehicle.

The mounting module can be coupled with the vehicle. The mounting module can stow or deploy a device or object. For example, the mounting module can stow a vehicle jack in a position that is within the vehicle and the mounting module can deploy the vehicle jack to a position that is external the vehicle.

At least one aspect is directed to an apparatus. The apparatus can include a shelving module. The shelving module can include a brace. The brace can couple the shelving module, in a first position, with a structure of an electric vehicle, and the brace can couple the shelving module, in a second position, with the structure of the electric vehicle.

At least one aspect is directed to a method. The method can include connecting a shelving module with a brace. The brace can couple the shelving module, in a first position, with a structure of an electric vehicle, and the brace can couple the shelving module, in a second position, with the structure of the electric vehicle.

At least one aspect is directed to an electric vehicle. The electric vehicle can include an apparatus. The apparatus can include a shelving module. The shelving module can include a brace. The brace can couple the shelving module, in a first position, with a structure of the electric vehicle, and the brace can couple the shelving module, in a second position, with the structure of the electric vehicle.

At least one aspect is direct to an apparatus. The apparatus can include a post. The post can couple with an electric vehicle. The post can cause at least a portion of an arm to be disposed external to the electric vehicle.

At least one aspect is directed to a method. The method can include disposing a post within an electric vehicle, the post can couple with the electric vehicle, and the post can cause at least a portion of an arm to be disposed external to the electric vehicle.

At least one aspect is directed to an electric vehicle. The electric vehicle can include an apparatus. The apparatus can include a post. The post can be coupled with the electric vehicle. The post can cause at least a portion of an arm to be disposed external to the electric vehicle.

At least one aspect is directed to a vehicle. The vehicle can include a power source. The power source can provide a DC voltage. The vehicle can also include a convertor. The convertor can convert the DC voltage to an AC voltage. The vehicle can also include a lifting device. The lifting device can receive the AC voltage and the lifting device can include an arm and a post. The arm can adjust from a first length to a second length. The post can support the lifting device and the post can rotate the arm from a first position to a second position.

At least one aspect is directed to an apparatus. The apparatus can include a mechanism. The mechanism can couple with an electric vehicle. The mechanism can move an arm to stow a device inside the electric vehicle and to deploy the device external to the electric vehicle.

At least one aspect is directed to an electric vehicle. The electric vehicle can include an apparatus, a storage compartment, and a track. The apparatus can include a mechanism. The mechanism can be coupled with the electric vehicle. The mechanism can move an arm to stow a device inside the electric vehicle and to deploy the device external to the electric vehicle. The storage compartment can hold a component and a portion of the storage compartment can be located between a body of the electric vehicle and a ground surface. The track can couple an object with the electric vehicle and the track can adjust the object from a first position to a second position.

At least one aspect is directed to a method. The method can include connecting a mechanism with an arm. The mechanism can couple with an electric vehicle, and the mechanism can move the arm to stow a device inside the electric vehicle and to deploy the device external to the electric vehicle.

At least one aspect is directed to a vehicle. The vehicle can include an apparatus. The apparatus can include a storage compartment and the apparatus can include a track. The storage compartment can hold a component and a portion of the storage compartment can be located between the vehicle and a surface. The track can be coupled the vehicle with an object and the track can adjust the object from a first position to a second position.

At least one aspect is directed to a method. The method can include providing an apparatus. The apparatus can include a storage compartment and a track. The method can include holding a component, locating a portion of the storage compartment between a vehicle and a surface, coupling the vehicle with an object, and adjusting the object from a first position to a second position.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts an example apparatus, in accordance with an implementation.

FIG. 3 depicts an example view of a shelving module, in accordance with an implementation.

FIG. 4 depicts an example apparatus, in accordance with an implementation.

FIG. 5 depicts an example apparatus, in accordance with an implementation.

FIG. 6 depicts an example apparatus, in accordance with an implementation.

FIG. 7 depicts an example apparatus, in accordance with an implementation.

FIG. 8 depicts an example view of a lift device, in accordance with an implementation.

FIG. 9 depicts an example apparatus, in accordance with an implementation.

FIG. 10 depicts an example apparatus, in accordance with an implementation.

FIG. 11 depicts an example view of a vehicle, in accordance with an implementation.

FIG. 12 depicts an example apparatus, in accordance with an implementation.

FIG. 13 depicts an example apparatus, in accordance with an implementation.

FIG. 14 depicts an example mounting module, in accordance with an implementation.

FIG. 15 depicts an example mounting module, in accordance with an implementation.

FIG. 16 depicts an example system to control an apparatus, in accordance with an implementation.

FIG. 17A depicts an example flow diagram of a process to provide an apparatus, in accordance with an implementation.

FIG. 17B depicts an example flow diagram of a method of manufacturing an apparatus, in accordance with an implementation.

FIG. 18A depicts an example flow diagram of a process to provide an apparatus, in accordance with an implementation.

FIG. 18B depicts an example flow diagram of a method of manufacturing an apparatus, in accordance with an implementation.

FIG. 19A depicts an example flow diagram of a process to provide an apparatus, in accordance with an implementation.

FIG. 19B depicts an example flow diagram of a method of manufacturing an apparatus, in accordance with an implementation.

FIG. 20 depicts an example flow diagram of a process to provide an apparatus, in accordance with an implementation.

FIG. 21 depicts an example apparatus, in accordance with an implementation.

FIG. 22 depicts an example apparatus, in accordance with an implementation.

FIG. 23 depicts an example apparatus, in accordance with an implementation.

FIG. 24 depicts an example apparatus, in accordance with an implementation.

FIG. 25 depicts an example view of a vehicle, in accordance with an implementation.

FIG. 26 depicts an example apparatus, in accordance with an implementation.

FIG. 27 depicts an example apparatus, in accordance with an implementation.

FIG. 28 depicts an example view of a vehicle, in accordance with an implementation.

FIG. 29 depicts an example view of a vehicle, in accordance with an implementation.

FIG. 30 depicts an example view of a vehicle, in accordance with an implementation.

FIG. 31 depicts an example view of a vehicle, in accordance with an implementation.

FIG. 32 depicts an example view of a vehicle, in accordance with an implementation.

FIG. 33 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of providing an apparatus. The various concepts introduced above and discussed in greater detail below may be implemented in any of numerous ways.

The present disclosure includes systems and methods of providing an apparatus. The apparatus can include components and the apparatus or the components can be mounted, attached, placed, secured or coupled with a vehicle. For example, the apparatus can be coupled with a fleet vehicle and the apparatus can be used, by an operator, to perform a function.

The apparatus can include a shelving module. The shelving module can be mounted, attached, placed, secured or coupled with the vehicle. For example, the shelving module can be attached to a wall of a vehicle or the shelving module can be attached to a support structure (e.g., a bracket, a beam, a post, a portion of framing, a fixture, or a rack) associated with the vehicle. The shelving module can be or include at least one of a shelf, a ledge, a rack or any other possible storage component or shelving component.

The shelving module can have at least one of an attached location, an attached position, an attached orientation, an attached configuration, an attached layout, an attached arrangement or an attached order. For example, the shelving module can be coupled with the vehicle in a position (e.g., an attached position). The first position can have an orientation (e.g., the attached orientation). The shelving module can have at least one surface and the surface can have at least one orientation. For example, while the shelving module is in the first position the surface can have a first orientation (e.g., the surface is orientated a certain way or the surface is facing a certain direction). For example, the first orientation can include a first portion of the surface facing the floor of the vehicle.

The shelving module can be removed, detached, unsecured or otherwise decoupled from the vehicle and the shelving module can be recoupled or otherwise attached to the vehicle in at least one of a new position, a new orientation, a new layout, a new arrangement or a new order. For example, the shelving module can be coupled with the vehicle in a first position and the shelving module can be in a first orientation while in the first position. The shelving module, while in the first position, can be decoupled from the vehicle. The shelving module can be recoupled with the vehicle in a second position. The second position can be different than the first position. The second position can have a second orientation. The second orientation can be the same as the first orientation or the second orientation can be different than the first orientation.

This technical solution provides a shelving module that be customized, altered, reconfigured or otherwise adapting by allowing the shelving module to change position or orientation within the vehicle. The shelving module can be removed to provide additional space for larger objects that would otherwise not fit within the vehicle while the shelving module is coupled with the vehicle. The vehicle can include or be provided the support structure that enables the shelving module to be coupled or recoupled with the vehicle. The support structure occupies or consumes very minimal space within the vehicle and the shelving module can be coupled with the vehicle without the use of tools.

Additionally, this technical solution enables the weight of the vehicle to be easily adjusted allowing for the vehicle to carry a load that otherwise would not be able to be carried by the vehicle if the shelving module were not able to be removed from the vehicle.

The apparatus can include a lift device. The lift device can be mounted, attached, placed, secured or coupled with the vehicle. For example, the lift device can be attached to the floor of the vehicle. The lift device can be stowed and the lift device can be deployed. The lift device can be stowed in a position that is within the vehicle (e.g., a stowed position) and the lift device can be deployed to a position that is external to the vehicle. The lift device can be or include at least one of a crane, a crank, a hoist, a winch or any other possible device or component that can lift at least one object. The lift device can be manual powered or the lift device can be provided power by a power source. For example, the vehicle can include a battery and the battery can provide power to the lift device. The lift device can bend, collapse, fold, bunch or otherwise decrease the area or space that the lift device occupies while located within the vehicle.

This technical solution enables a vehicle to carry a lift device while also reducing the amount of area or space that is occupied by the lift device. By decreasing the area that is occupied by the lift device the vehicle is able to carry additional equipment, packages, or objects that would otherwise not be able to be carried by the vehicle.

The apparatus can include a mounting module. The mounting module can be mounted, attached, placed, secured or coupled with the vehicle. For example, the mounting module can be attached to a wall of the vehicle. The mounting module can stow and the mounting module can deploy an object. For example, the mounting module can stow and deploy a vehicle jack. The object can be coupled with the mounting module. The mounting module can pivot, adjust, rotate, turn, swivel or otherwise move the object from a position that is within the vehicle to a position that is external to the vehicle.

This technical solution enables the operator of the vehicle to be provided the object that is coupled with the mounting module while allowing the operator to remain external to the vehicle. The objects that can be coupled with the mounting module can be extremely heavy which makes moving the objects very difficult. The mounting module decreases the amount of effort required by the operator to move the object from a stowed position to a deployed position.

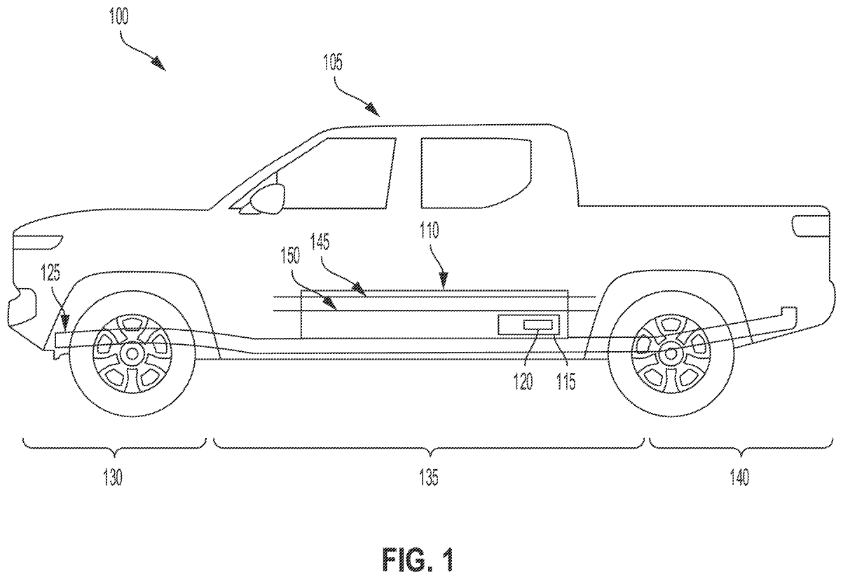

FIG. 1 depicts an example cross-sectional view 100 of a vehicle 105 installed with at least one battery pack 110. The vehicle 105 can include electric vehicles 105, and can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

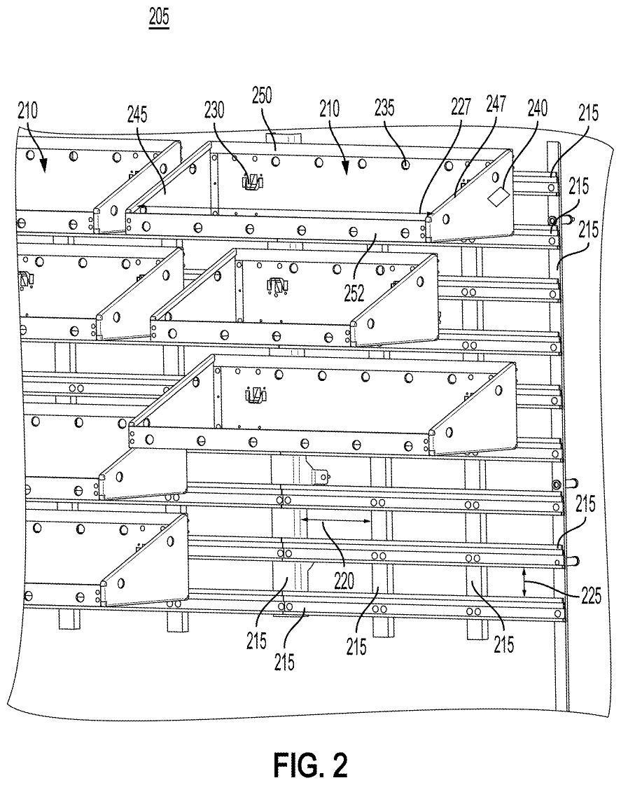

FIG. 2 depicts an apparatus 205. The apparatus 205 can be mounted, attached, placed, secured or coupled with a vehicle. For example, the apparatus 205 can be coupled with the vehicle 105. The apparatus 205 can include at least one shelving module 210 and at least one structure 215. The structure 215 can be or include a support structure. The shelving module 210 can be mounted, attached, placed, secured or coupled with the support structure 215. The shelving module 210 can be coupled with the support structure 215 in at least one position. For example, the shelving module 210 can be coupled with the support structure 215 in a first position or a second position. The first position and the second position can be the same position or the first position and the second position can be different positions. The first position can have a first height and the second position can have a second height. The first height and the second height can be different. For example, the shelving module 210 while in the first position can be 24 inches (e.g., the first height) away from the floor of the vehicle 105 and the shelving module 210 while in the second position can be 30 inches (e.g., the second height) away from the floor of the vehicle 105. The support structure 215 can support the shelving module 210 and the support structure 215 can couple the shelving module 210 with the vehicle 105. For example, the support structure 215 can support the shelving module 210 by holding, affixing, securing, or otherwise maintaining the position of the shelving module 210.

The shelving module 210 can include at least one locking mechanism 230, at least one opening 235, at least one coupling mechanism 240, at least one first side structure 245 (e.g., a face 245), at least one second side structure 247 (e.g., a second face 247), at least one back structure 250 or at least one front structure 252. The shelving module 210 can have at least one length 227. For example, the length 227 can be 12 inches, or between six and 18 inches, as well as greater than 18 inches or less than six inches. The length 227 can be measured from at least one of the center, the outermost portion or the innermost portion of the first side structure 245 to at least one of the center, the outermost portion or the innermost portion of the second side structure 247.

The locking mechanism 230 can lock the shelving module 210 in at least one position. For example, the locking mechanism 230 can lock the shelving module 210 in the first position. The locking mechanism 230 can lock the shelving module 210 by preventing the shelving module 210 to be decoupled from the support structure 215. For example, the shelving module 210 can be lifted, hinged or otherwise moved to decouple the shelving module 210 from the support structure 215. The locking mechanism 230 can occupy or otherwise make contact with a portion of the support structure 215 (e.g., a recess in the support structure 215) and the locking mechanism 230 occupying the portion of the support structure 215 can prevent the shelving module 210 from being decoupled from the support structure 215. The locking mechanism 230 can be at least one of a latch, a clasp, a bolt, a clip or a fastener. An operator of at least one of the vehicle 105 or the apparatus 205 can pull on the locking mechanism 230 or a spring, a hydraulic, a piston or a knob of the locking mechanism 230 to have the locking mechanism 230 make contact with the support structure 215 or to prevent the locking mechanism 230 from making contact with the support structure 215.

The opening 235 can enable an object to couple with the shelving module 210. For example, the object can be a bungie cord and the opening 235 can enable the bungie cord or a hook associated with the object to couple with the shelving module 210. The opening 235 can also enable an operator of the vehicle 105 or the apparatus 205 to be able to view a portion of the shelving module 210 that would otherwise be blocked or obstructed if the opening 235 was enclosed.

The coupling mechanism 240 can couple the shelving module 210 with at least one additional shelving module (e.g., at least one second shelving module 210). For example, the coupling mechanism 240 can couple the shelving module 210 with the second shelving module 210. The coupling mechanism 240 can be or included at least one of a latch, a clamp or any other possible component that can be used to couple the shelving module 210 with the second shelving module 210. The coupling mechanism 240 can be designed, shaped, configured or otherwise formed to couple the shelving module 210 with the second shelving module 210. The coupling mechanism 240 can enable to shelving module 210 to hold a component that is larger than the shelving module 210 or larger than the length 227. For example, the shelving module 210 and the second shelving module 210 once coupled with one another can have a length that is larger than the length 227. This can enable the shelving module 210 or the second shelving module 210 to hold a component that is larger than the shelving module 210 or the second shelving module 210.

The support structure 215 can be mounted, attached, placed, secured or coupled with at least one addition support structure (e.g., at least one second support structure 215). The support structure 215 or the second support structure 215 can be mounted, attached, placed, secured or coupled with the vehicle 105. The support structure 215 can be perpendicular to, parallel to or can have any other possible orientation to the second support structure 215. The support structure 215 can be placed, orientated, or otherwise position in a vertical configuration, a horizontal configuration or any other possible orientation or configuration. The second support structure 215 can be placed, orientated, or otherwise position in a vertical configuration or a horizontal configuration. FIG. 2 depicts an example of at least one support structure 215 in a horizontal configuration and at least one support structure 215 in a vertical configuration.

The support structure 215 can have a distance, a length or a gap between at least one additional support structure (e.g., the second support structure 215). The support structures 215 can be separated by a length 220 or a length 225. The length 220 can be based on, related to or dependent on the length 227. The length 225 can be based on, related to or dependent on the length 227. The length 227 can be one in a half times larger than the length 220. For example, the length 220 can be 10 inches and the length 227 can be 15 inches. The length 220 can represent a distance between support structures 215 when the support structures 215 are in a vertical configuration. The length 225 can represent a distance between support structures 215 when the support structures 215 are in a horizontal configuration.

At least one of the first side structure 245, the second side structure 247, the back structure 250 or the front structure 252 can prevent the components, held by the shelving module 210, from escaping. For example, the first side structure 245 can create, form or otherwise provide a barrier that blocks the components from falling, sliding off, or otherwise exiting the shelving module 210.

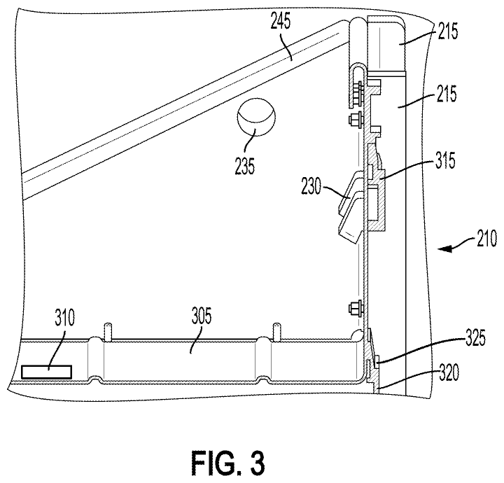

FIG. 3 depicts an example view of the shelving module 210. FIG. 3 depicts a cross section view of the shelving module 210. The shelving module 210 or the apparatus 205 can include at least one surface 305, at least one liner 310, at least one brace 315 and at least one track 325. The surface 305 can hold at least one component. For example, the surface 305 can hold a power tool battery pack and the surface 305 can hold the power tool battery pack by allowing the power tool battery pack to rest on, make contact with or otherwise reside on the surface 305. The liner 310 can be mounted, attached, placed, secured or coupled with surface 305. The liner 310 can be or include at least one of a polyurethane coat, a polyurea coat, a wax coat, a Velcro coat, a carpet coat or any other possible material that can be lined to the surface 305.

The surface 305 can have at least one friction metric. The friction metric can indicate how easily an object can slide, glide or otherwise move across, along or on the surface 305. For example, a friction metric that is equal to 1 can indicate that objects will slide across the surface 305 similar to how the object would slide across ice. A friction metric that is equal to 0.1 can indicate that objects will slide across the surface 305 similar to how the object would slide across sand. The liner 310 can adjust the friction metric associated with the surface 305. The liner 310 can adjust the friction metric associated with the surface 305 by increasing, decreasing or otherwise changing the value of the friction metric associated with the surface 305. For example, the liner 310 can adjust the friction metric by increasing the value of the friction metric which results in objects being able to slide across the surface 305 much easier when compared to the friction metric prior to being adjusted by the liner 310.

The brace 315 can be mounted, attached, placed, secured or coupled with the support structure 215. The support structure 215 can couple the brace 315 with the vehicle 105. The brace 315 can be configured to rest in, slide in or otherwise make contact with at least one portion (e.g., at least one recess 320) of the support structure 215. The brace 315 can be coupled with the support structure 215 or the recess 320 similar to a French cleat configuration. For example, the brace 315 can slide over, come into contact with or otherwise rest on the support structure 215. In response to the brace 315 making contact with the support structure 215 or the recess 320 the shelving module 210 can be coupled with the support structure 215. The brace 315 can couple the shelving module 210 at a first position of the support structure 215 and the brace can couple the shelving module 210 at a second position of the support structure 215. For example, the brace 315 can reversibly couple the shelving module 210 with the support structure 215 (e.g., the brace 315 can couple the shelving module 210 with the support structure 215 and the brace 315 can decouple the shelving module 210 from the support structure 215). The first position and the second position can be different. The brace 315 can be removable from the first position (e.g., decoupled from the support structure 215 at the first position) and the brace 315 can couple with the support structure 215 at the second position. The recess 320 can be or include at least one of a receptacle, an alcove, a niche, an indent, a groove or any other possible opening that can accept, receive or otherwise make contact with at least a portion of the brace 315. The recess 320 can receive at least a portion of the brace 315 and the recess 320 can couple with the brace 315 in at least one of the first position or the second position described herein. The brace 315 or a portion of the brace 315 can, via the track 325, slide, glide, run or otherwise move from the recess 320 to a second recess (e.g., a second recess 320). For example, an operator of the apparatus 205 can make contact with at least one of the shelving module 210 or the brace 315 and can move the brace 315 from the recess 320 that is currently making contract with the brace 315 to a second recess 320.

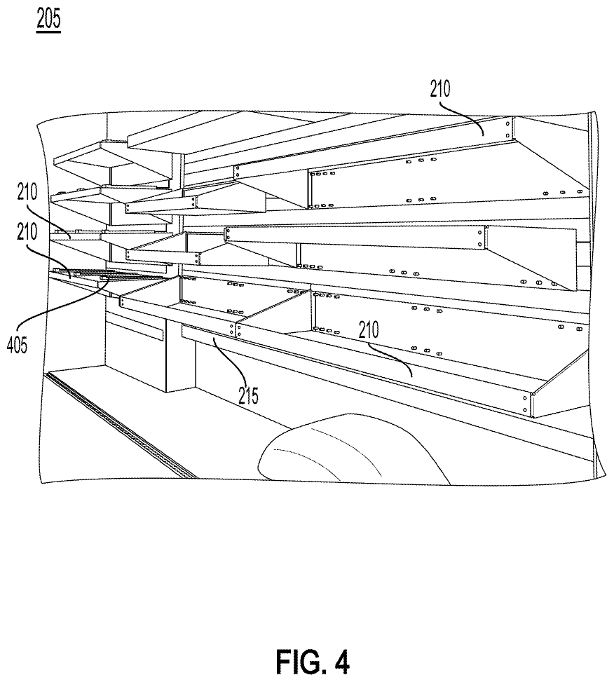

FIG. 4 depicts an example of the shelving module 210 and at least one second shelving module 210. The shelving module 210 can include at least one partition 405. The partition 405 can separate, create, or otherwise divide the shelving module 210 or the surface 305 into at least one portion. For example, the partition 405 can divide the surface 305 into a first portion and a second potion. The first portion and the second portion can separate components, being held by the surface 305 or the shelving module 210, that are located on the shelving module 210. FIG. 4 depicts an example of the shelving module 210 in a first position and a first orientation, an example of at least one second shelving module 210 in a second position and a second orientation. As can be seen in FIG. 4 the first position and the second position have different heights (e.g., the second shelving module 210 is located in a position that is higher than the position of the shelving module 210). The first orientation of the shelving module 210 and the second orientation of the second shelving module 210 are different by 180 degrees (e.g., the first and second orientation would match if one of the shelving modules 210 were rotated by 180 degrees). The shelving module 210 can be turned upside down to move from the first orientation to the second orientation.

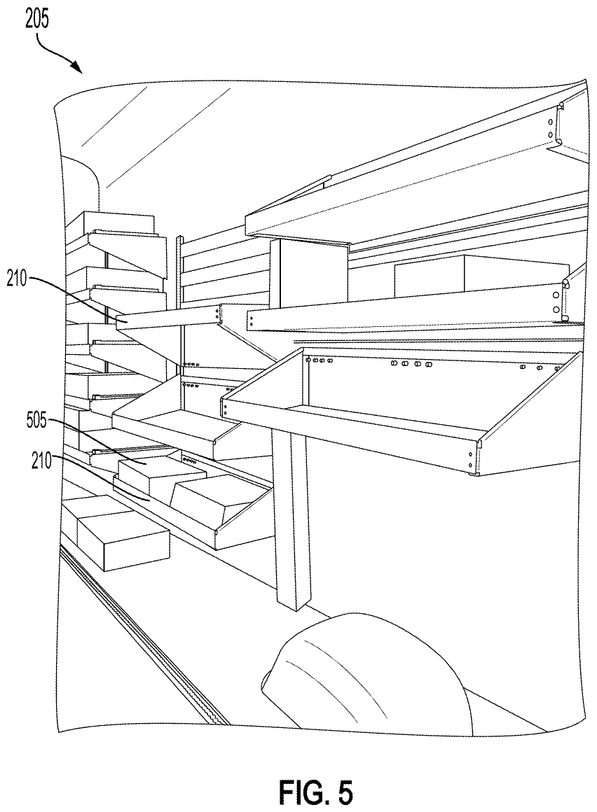

FIG. 5 depicts an example of the apparatus 205. FIG. 5 depicts the shelving module 210 holding at least one component 505. FIG. 5 also depicts an example of the orientation of the shelving module 210 and the orientation of a second shelving module 210 being different (e.g., the top shelving module 210, as depicted in FIG. 5, is upside down relative to the bottom shelving module 210 as depicted in FIG. 5).

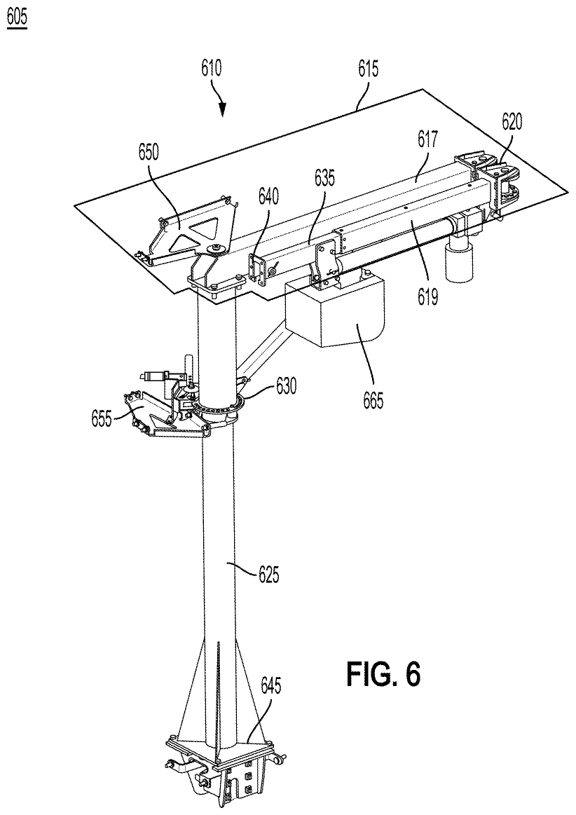

FIG. 6 depicts an apparatus 605. The apparatus 605 can include at least one lift device 610. The lift device 610 can include at least one arm 615, at least one post 625, at least one stopping mechanism 630, at least one first mount 650, at least one second mount 655, at least one locking mechanism 660 and at least one motor 665. The apparatus 605 can be mounted, attached, placed, secured or coupled with the vehicle 105.

The arm 615 can include at least one first portion 617, at least one second portion 619, at least one hinge 620, at least one extendable portion 635 and at least one plate 640. The hinge 620 can be mounted, attached, placed, secured or coupled with both the first portion 617 and the second portion 619. The hinge 620 can swivel, articulate, turn, extend or otherwise adjust the second portion from a first orientation to a second orientation. FIG. 6 depicts the second portion 619 in a collapsed orientation (e.g., the first orientation). The length of the first portion 617 and the second portion 619 can be the same length. The arm 615 can adjust from a first length (e.g., the length of the first portion 617 or the length of the second portion 619) to a second length (e.g., the length of the first portion 617 plus the length of the second portion 619). The hinge 620 adjusting the second portion 619 from the first position to the second position can adjust the length of the arm 615. The second portion 619 can include an extendable portion 635 and the extendable portion can have a plate 640. The extendable portion 635 can adjust the length of the second portion 619 or the extendable portion 635 can adjust the length of the arm 615. The plate 640 can be mounted, attached, placed, secured or coupled with at least one component. For example, a hook can be coupled with the plate 640.

The post 625 can be mounted, attached, placed, secured or coupled with the arm 615 and the vehicle 105. The post can include at least one base 645. The post 625 can support the lift device 610 and the post 625 can rotate, move or otherwise adjust the arm 615 from a first position to a second position. For example, the post 625 can move the arm 615 from a position that is within the vehicle 105 (e.g., the first position) to a position that is external to the vehicle 105 (e.g., the second position). The post 625 can rotate the arm 615 from the second position to a third position. The third position can be a position that is external to the vehicle 105. The base 645 can be mounted, attached, placed, secured or coupled with the floor of the vehicle 105. The post 625 can have a portion that is coupled with the arm 615 and the portion coupled with the arm 615 can rotate, swivel, or otherwise change the position of the arm 615. FIG. 6 depicts an example of the post 625 supporting the lift device 610 and an example of the post 625 having rotated the arm 615 to a first position.

The stopping mechanism 630 can prevent the post 625 from moving the arm 615 beyond a predetermined position. For example, the stopping mechanism 630 can make contact with the portion of the post 625 that rotates the arm 615 and the stopping mechanism 630 making contact with the portion of the post 625 that rotates the arm 615 can prevent the post 625 from rotating the arm 615 beyond the predetermined position. The mount 650 and the mount 655 can support at least one of the arm 615, the post 625, the lift device 610 or the apparatus 605. The mount 650 and the mount 655 can be mounted, attached, placed, secured or coupled with the lift device 610 and the vehicle 105. For example, the mount 650 and the mount 655 can be attached to a wall of the vehicle 105, the arm 615 or the post 625. The locking mechanism 660 can hold, maintain or otherwise lock the arm 615 in at least one of the first position or the second position. The locking mechanism 660 can be or include at least one of a latch, a clasp, a bolt, a clip or a fastener. At least a portion of the lift device 610 can be electrically coupled with a power source. For example, at least a portion of the lift device 610 can be electrically coupled with the battery pack 110.

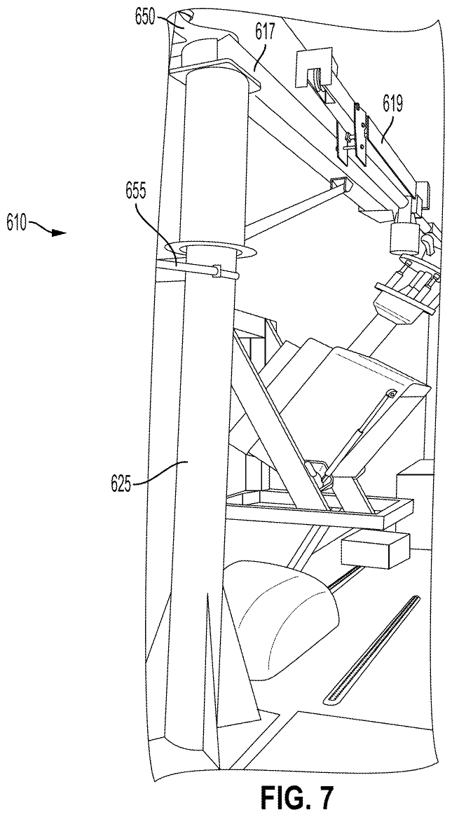

FIG. 7 depicts an example of the lift device 610. FIG. 7 depicts an example of the arm 615 in a first position that is within the vehicle 105, an example of the post 625 supporting the arm 615, an example of the post 625 having rotated the arm 615 to the first position, an example of hinge 620 having collapsed the second portion 619 towards the first portion 617, an example of the mount 650 and the mount 655 supporting the arm 615 and post 625.

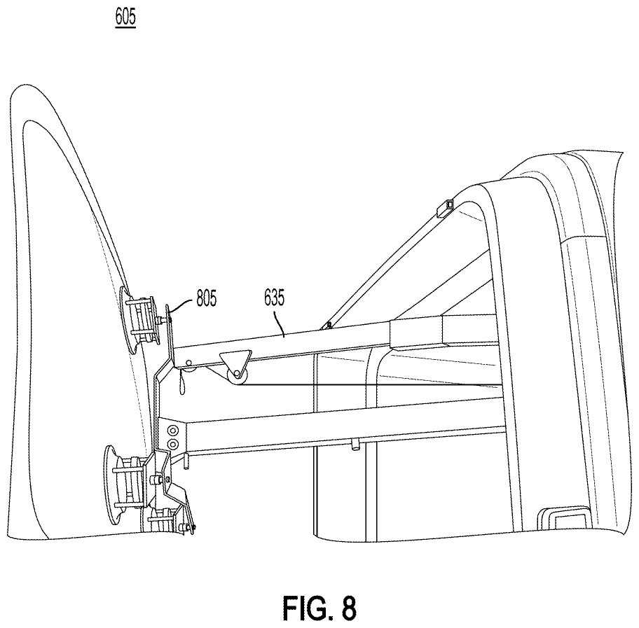

FIG. 8 depicts an example view of the lift device 610. The lift device 610 can include at least one grabbing mechanism 805. The grabbing mechanism 805 can be mounted, attached, placed, secured or coupled with the plate 640. The grabbing mechanism 805 can be or include at least one of a hook, a glass suction cup, a clamp, a pallet fork, a grapple, or any other possible device that can grab, attach to or hold at least one object. FIG. 8 depicts an example of the post 625 having moved the arm 615 to a position that is external to the vehicle 105, an example of the extendable portion 635 having extending the length of the second portion 619 and an example of a suction cup (e.g., the grabbing mechanism 805) having grabbed a window (e.g., the object).

The motor 665 can be coupled with at least one of the arm 615, the post 625, or the grabbing mechanism 805. The motor 665 can also receive power from a battery of the vehicle. For example, the motor 665 can receive power from the batteries 115 of the vehicle 105. The motor 665 can adjust the grabbing mechanism 805 from a first height to a second height. For example, the motor can move a cable of the grabbing mechanism 805 from an elevated position (e.g., a first height) to a lowered position (e.g., a second height). The second height can be proximate to a ground surface. The motor 665 can also move the arm 615 from a first position to a second position. For example, the motor 665 can move the arm 615 from a position inside of the vehicle 105 (e.g., a first position) to a position that is external to the vehicle 105 (e.g., a second position). The batteries 115 can also provide power to move the vehicle 105. For example, the batteries 115 can provide power to a motor to drive, rotate, and/or otherwise move the wheels of the vehicle 105.

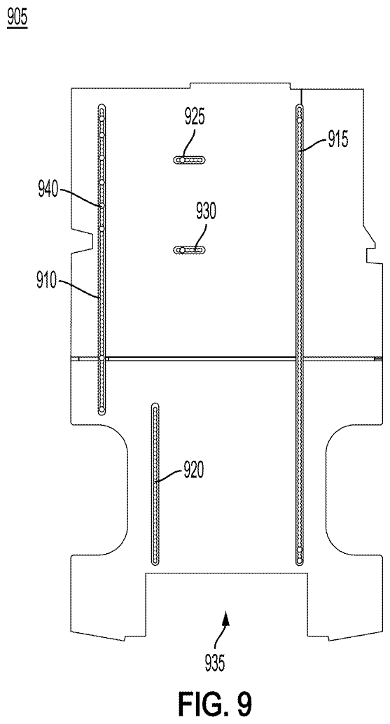

FIG. 9 depicts an apparatus 905. The apparatus 905 can include at least one first track 910, at least one second track 915, at least one third track 920, at least one fourth track 925, at least one fifth track 930 and at least one gap 935. At least one of the first track 910, the second track 915, the third track 920, the fourth track 925 or the fifth track 930 can enable a component or object to be coupled with a vehicle (e.g., the vehicle 105) while also enabling the object to slide, move, rotate or otherwise change the position of the object with respect to the vehicle 105. For example, the object can adjust from a first position to a second position. The gap 935 can provide an area that allows an object to be coupled with the apparatus 905. For example, a storage compartment can be located in the gap 935 and the storage compartment can be coupled with the apparatus 905. At least one of the first track 910, the second track 915, the third track 920, the fourth track 925 or the fifth track 930 can include an opening 940. The opening 940 can enable the object to decouple from at least one of the first track 910, the second track 915, the third track 920, the fourth track 925 or the fifth track 930 and the opening 940 can allow the object to couple with at least one of the first track 910, the second track 915, the third track 920, the fourth track 925 or the fifth track 930 in a third position. The third position can be different from at least one of the first position or the second position. The object while in the third position have an orientation (e.g., a first orientation) that is different that an orientation (e.g., a second orientation) of at least one of the first position or the second position.

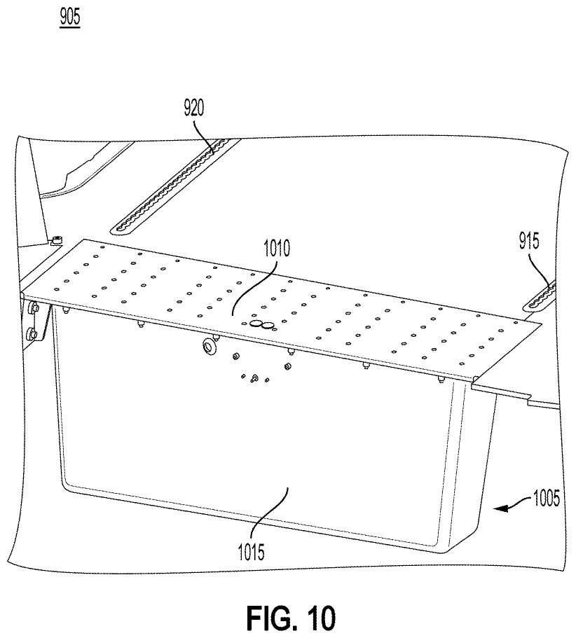

FIG. 10 depicts the apparatus 905. The apparatus 905 can include a storage compartment 1005. The storage compartment 1005 can be located in the gap 935. The storage compartment 1005 can include at least one lid 1010 and at least one housing 1015. The lid 1010 can enclose the storage compartment 1005 and the housing 1015 can store at least one component. For example the housing 1015 can store a power tool. A portion of the storage compartment 1005 can be located between at least one of the floorboard of the vehicle, the undercarriage of the vehicle, the chassis of the vehicle, the battery pack of the vehicle, the skateboard of the vehicle or the body of the vehicle and a ground surface. The ground surface can be or include at least one of a road, a dirt road, an off-road, an interstate, the earth or any other possible surface. The storage component 1005 is located in a position of the vehicle 105 so that the operator of the vehicle 105 or the storage component 1005 can retrieve the components stored in the housing 1015 while the operator is external to the vehicle 105. The housing 1015 can include at least one opening that can allow for water to escape the housing 1015. The lid 1010 can be flush to at least one portion of the apparatus 905.

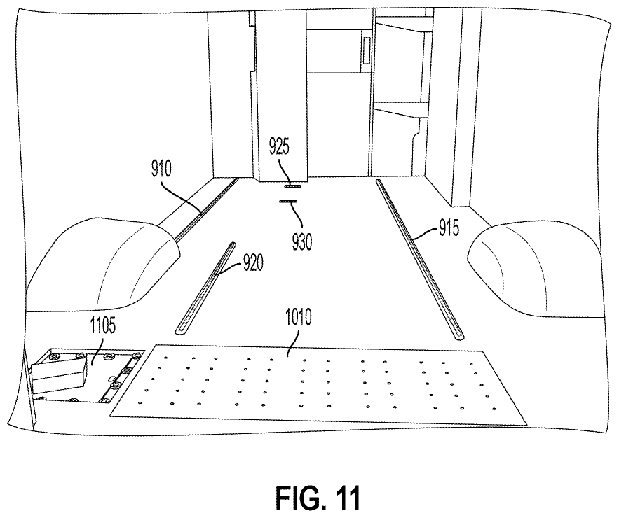

FIG. 11 depicts an example view of the vehicle 105. The vehicle 105 is shown to include the first track 910, the second track 915, the third track 920, the fourth track 925, the fifth track 930, the lid 1010 and at least one area 1105. The post 625 or the base 645 can be mounted, attached, placed, secured or coupled with the vehicle 105. For example, the base 645 can occupy the area 1105 and once the base 645 occupies the area 1105 the base 645 can be coupled with the vehicle 105.

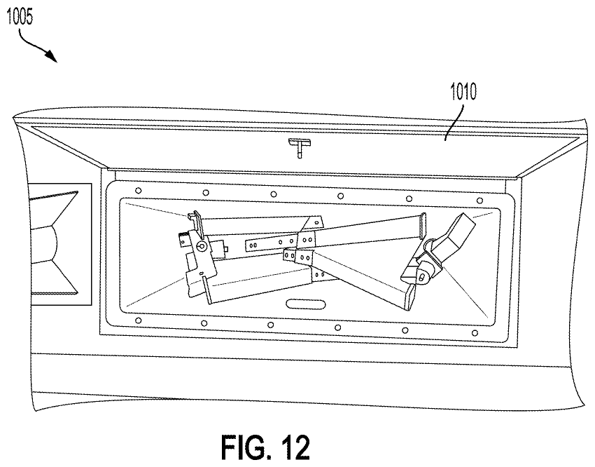

FIG. 12 depicts an example view of the storage compartment 1005. FIG. 12 shows an example of the lid 1010 in an opened position where the lid is not enclosing the storage compartment 1005 and an example of the housing 1015 storing objects.

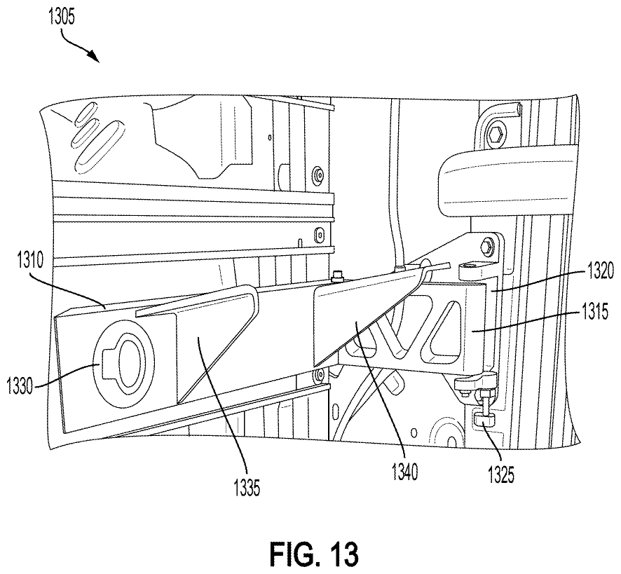

FIG. 13 depicts an apparatus 1305. The apparatus 1305 can include at least one mounting module 1310 and at least one locking mechanism 1325. The mounting module 1310 can include at least one arm 1315, at least one mechanism 1320, at least one assisting device 1330, at least one first support portion 1335 and at least one second support portion 1340. The first support portion 1335 and the second support portion 1340 can be a supporting module. The mounting module 1310 can be mounted, attached, placed, secured or coupled with a vehicle. For example, the mounting module 1310 can be coupled with the vehicle 105. The mounting module 1310 can hold, rest or otherwise support at least one object or device. For example, the mounting module 1310 can hold a vehicle jack. The first support portion 1335 and the second support portion 1340 enable the mounting module 1310 to hold the object. The arm 1315 can stow the object and the arm 1315 can deploy the object. For example, the arm 1315 can stow the object in a position that is within the vehicle 105 and the arm 1315 can deploy the object to a position that is external to the vehicle 105.

The mechanism 1320 can be a pivoting mechanism. The pivoting mechanism 1320 can be mounted, attached, placed, secured or coupled with the vehicle 105 and the arm 1315. The pivoting mechanism 1320 can rotate the arm 1315. The pivoting mechanism 1320 enables the arm 1315 to stow the object and the pivoting mechanism 1320 enables the arm 1315 to deploy the object. An operator of the apparatus 1305 or the mounting module 1310 can grab the assisting device 1330 to assist in the arm 1315 either deploying the object or to assist in the arm 1315 stowing the object. The assisting device 1330 can be or include at least one of a pull tab, a lever or a handle.

The locking mechanism 1325 can lock the arm 1315. For example, the locking mechanism 1325 can prevent the arm 1315 from stowing, while the arm 1315 has deployed the object, the object or the locking mechanism 1325 can prevent the arm 1315 from deploying, while the arm 1315 has stowed the object. The locking mechanism 1325 can be at least one of a latch, a clasp, a clip or a lock.

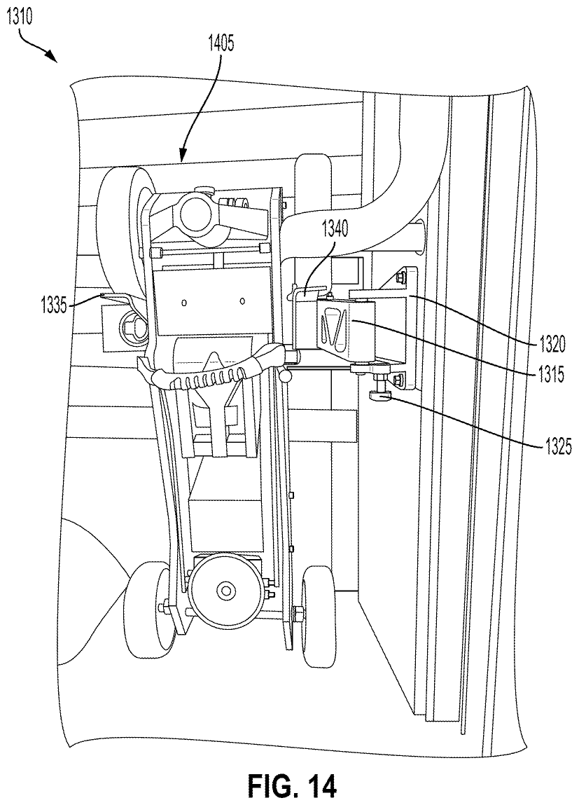

FIG. 14 depicts the mounting module 1310. FIG. 14 depicts an example of the mounting module 1310 holding a vehicle jack 1405 (e.g., an object), an example of the arm 1315 having stowed the vehicle jack 1405 in a stowed position that is within the vehicle 105 and an example of the first support portion 1335 and the second support portion 1340 supporting the vehicle jack 1405.

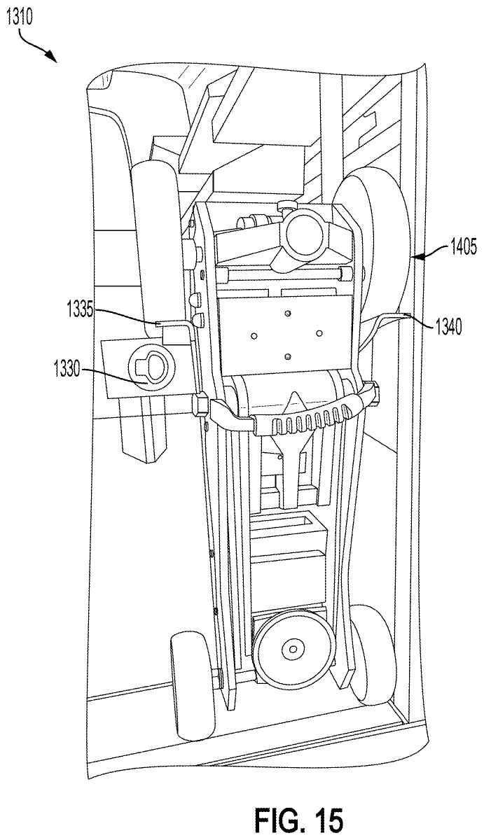

FIG. 15 depicts the mounting module 1310. FIG. 15 depicts an example of the mounting module 1310 holding the vehicle jack 1405, an example of the arm 1315 having deployed the vehicle jack 1405 to a deployed position that is external to the vehicle 105 and an example of the first support portion 1335 and the second support portion 1340 supporting the vehicle jack 1405. The pivoting mechanism 1320 can provide access to the vehicle jack 1405 from a position external to the vehicle. FIG. 15 depicts an example of the vehicle jack 1405 accessible, with the arm 1315 having deployed the vehicle jack 1405, from a position external to the vehicle. For example, an operator the vehicle can be located or otherwise positioned external to the vehicle (e.g., the operator is outside of the vehicle) and the operator can, while outside of the vehicle, access or grab the vehicle jack 1405. The arm 1315 can deploy to vehicle jack 1405 to a position that is at least partially external to the vehicle. The vehicle jack 1405 can be accessible from outside the vehicle with the vehicle 1405 in the position that is at least partially external to the vehicle. The position that is at least partially external to the vehicle can include the vehicle jack 1405 being located, placed, situated, or otherwise positioned towards the external of the vehicle. For example, the vehicle jack 1405 can be positioned proximate to a rear opening of the vehicle.

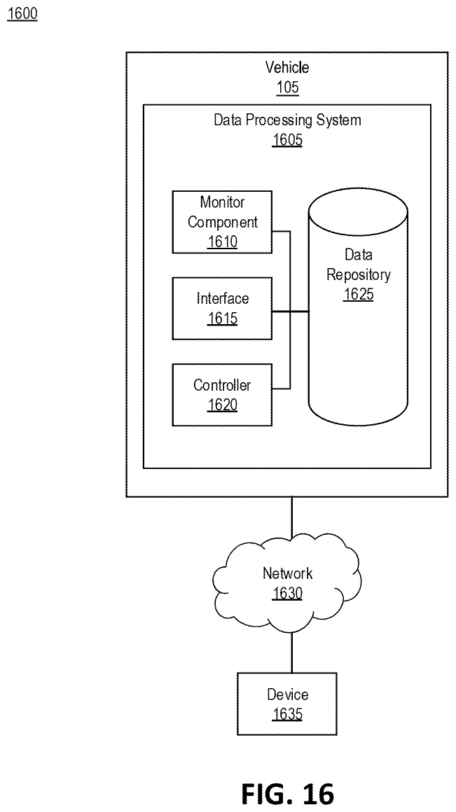

FIG. 16 depicts an example system 1600 to control an apparatus, in accordance with an implementation. The system 1600 can include vehicle 105. The vehicle 105 can include at least one apparatus described herein. For example, the vehicle 105 can include the apparatus 605. The apparatus 605 can include the lift device 610. The vehicle 105 can also include at least one data processing system 1605. The lift device 610 can include the arm 615 and the post 625. The data processing system 1605 can include at least one monitor component 1610, at least one interface 1615 and at least one control 1620. The monitor component 1610 can include at least one sensor. The sensors can collect data. The sensors can include at least one of a motion sensor, an interface sensor or a component sensor. The data processing system 1605 or at least one component of the data processing system 1605 can be external to the vehicle 105. For example, the data processing system 1605 can be a remote server system (e.g., a cloud based data processing system) or a data processing system that is included in or stored on a user device (e.g., a mobile phone or tablet). For example, the data processing system 1605 can be included in the apparatus 1305.

The monitor component 1610 can include, communicate with or otherwise interface with a motion sensor. The motion sensor can collect data that can be used to determine a position of the apparatus 605 or the lift device 610. For example, the motion sensor can determine that the arm 615 has been rotated by the post 625.

The monitor component 1610 can include, communicate with or otherwise interface with an interface sensor. The interface sensor can collect data that can be used to determine a selection on an interface. For example, the interface sensor can be a tactile sensor. The interface sensor can detect an operator of the apparatus 605 selecting at least one option presented on a user interface (e.g., interface 1615). For example, an operator can select on option to rotate the arm 615 from a first position to a second position.

An operator of the vehicle 105 or the apparatus 605, using the interface 1615, can perform one or more operations of the apparatus 605. For example, an operator can select an icon displayed by the interface 1615 to have the arm 615 adjust from a first length to a second length. Similarly, the operator can select an icon displayed by the interface 1615 to have the extendable portion 635 extend the length of the second portion 619.

The interface 1615, responsive to the operator selecting the icon to have the arm 615 extend from a first length to a second length, can communicate with the controller 1620. The controller 1620 can be mounted, attached, placed, secured or coupled with at least one of the apparatus 605, the lift device 610, the arm 615 or the post 625. The controller 1620, responsive to communicating with the interface 1615, can provide, to the hinge 620, a signal to swivel the second portion 619 from a first position to a second position. The hinge 620 swiveling the second portion 619 can adjust the length of the arm 615.

The interface 1615, responsive to the operator selecting the icon to have the extendable portion 635 extend the length of the second portion 619, can communicate with the controller 1620. The controller 1620, responsive to communicating with the interface 1615, can provide, to the extendable portion 635, a signal to extend the length of the second portion 619.

The data processing system 1605 and a user device 1635 can interface by using a network 1630. The user device 1635 can include at least one of a mobile phone, a smart watch, a tablet, a smart phone, an infotainment system of a vehicle (e.g., the infotainment system of the vehicle 105). An operator of the user device 1635 can perform similar operations to that performed by selecting icons on the interface 1615. For example, the user device 1635 can include an application that has been stored on the user device 1635 and is associated with the apparatus 605. For example, when an operator purchased the apparatus 605 or the vehicle 105 they received instructions of how to download the application and link the application with the apparatus 605. An operator of the user device 1635 can select an icon on an interface of the user device 1635 to have the extendable portion 635 extend the length of the second portion 619.

The data processing system 1605 can include at least one data repository 1625. The data repository 1625 can include, store, maintain or otherwise provide data. The data can be data that is collected and provided by the monitor component 1610, data that is collected and provided by the interface 1615 or data that is provided by the user device 1635.

The user device 1635 can receive from the data processing system 1605 information that pertains to at least one of scheduled service appoints that can be carried out by the operator of the vehicle 105 or the user device 1635, points of interests (e.g., service centers, mailing offices, restrooms, lodging, public parking) or locations of one or more additional vehicles (e.g., one or more additional vehicles 105). The operator of the vehicle 105 or the user device 1635 can accept, decline, flag or request additional information that pertains to at least one service request that the operator has received. The user device 1635 can also be used to transmit control signals to at least one component of the vehicle 105. For example, an operator of the user device 1635 can select an icon, displayed by the user device 1635, to have lights (e.g., the head lights or the tail lights) of the vehicle 105 flash.

The operator of the user device 1635 can also control a hotspot (e.g., internet) of the vehicle 105 by either activating or deactivating an icon, button, switch or toggle located on the user device 1635. The operator of the user device 1635 can also transmit signals to one or more additional user device 1635. For example, the operator of the user device 1635 or the vehicle 105 can transmit a notification to a person that has schedule a service appointment. The notification can include at least one of an estimated time of arrival, a delay in arrival or a location tracking feature. The operator of the user device 1635 can also cancel the transmission of the notification. For example, the operator can stop the location of the vehicle 105 being shared to the person that scheduled the service appointment.

The user device 1635 can also send control signals to a vehicle that is not associated with the operator of the user device 1635. For example, the user device 1635 can transmit a signal that causes the horn of a different vehicle honk. This can provide a better indication as to the location of the vehicle that is scheduled to be serviced by the operator of the user device 1635. The user device 1635 can be used to track the location of the operator in relation to the vehicle 105. For example, the user device 1635 can be in the possession of the operator of the vehicle 105 and the location of the user device 1635 can be compared to the location of the vehicle 105.

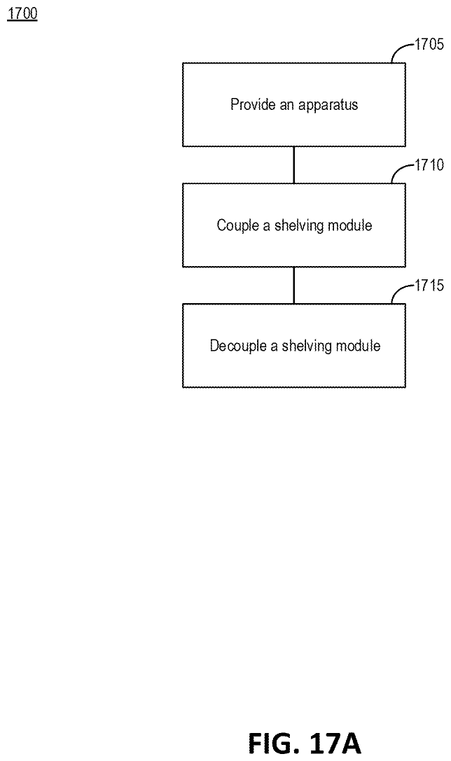

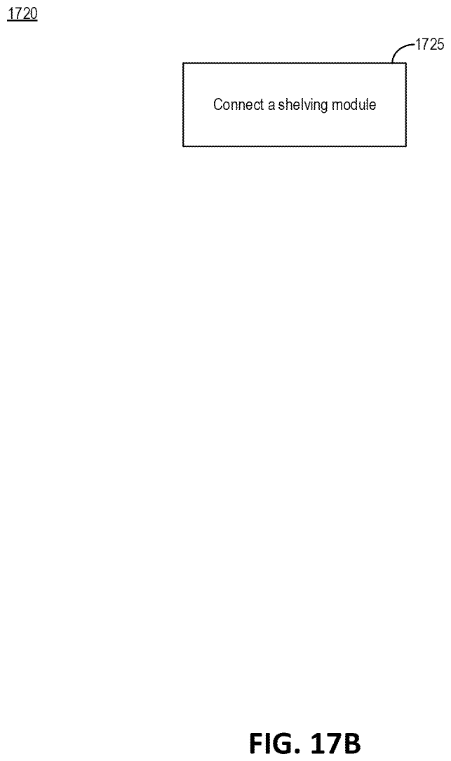

FIG. 17A is a flow diagram of a process 1700 where an apparatus can be provided, in accordance with an implementation. In ACT 1705, an apparatus can be provided. For example, the apparatus can be the apparatus 205. The apparatus 205 can be provided to the vehicle 105. The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a shelving module (e.g., the shelving module 210) and a support structure (e.g., the support structure 215). The shelving module 210 can include the surface 305 and the brace 315.

In ACT 1710, the shelving module 210 can be coupled. For example, the shelving module 210 can be coupled to at least one of the support structure 215 or the vehicle 105. The shelving module 210 can be coupled, responsive to the brace 315 making contact with the support structure 215, with the support structure 215.

In ACT 1715, the shelving module 210 can be decoupled. For example, the shelving module 210 can be decoupled to the support structure 215. The shelving module 210 can be decoupled, responsive to the brace 315 no longer making contact with the support structure 215, from the support structure 215.

FIG. 17B is a flow diagram of a method 1720 of manufacturing an apparatus, in accordance with an implementation. The apparatus can be the apparatus 205. The apparatus can include the shelving module 210. In ACT 1725, a shelving module can be connected. For example, the shelving module can be the shelving module 210. The shelving module 210 can be connected to the brace 315. The brace 315 can couple the shelving module 210 with a structure (e.g., the support structure 215). The shelving module 210 can couple with the structure at a first position and at a second position. For example, the shelving module 210 can couple with the structure at the first position via the brace 315. The shelving module 210 can, via the brace 315, decouple from the structure. The shelving module 210 can, via the brace 315, couple with the structure at the second position. The shelving module 210 coupling with the structure at the first position, decoupling from the structure at the first position, and the coupling with the structure at the second position is an example of the brace 315 reversibly coupling the shelving module 210 with the structure.

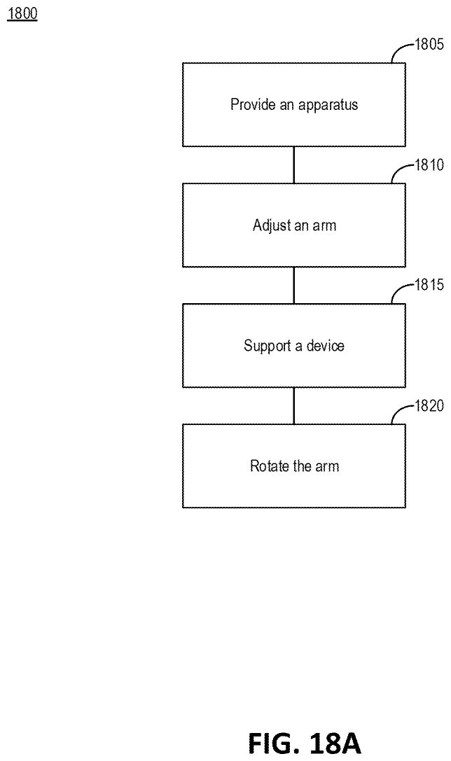

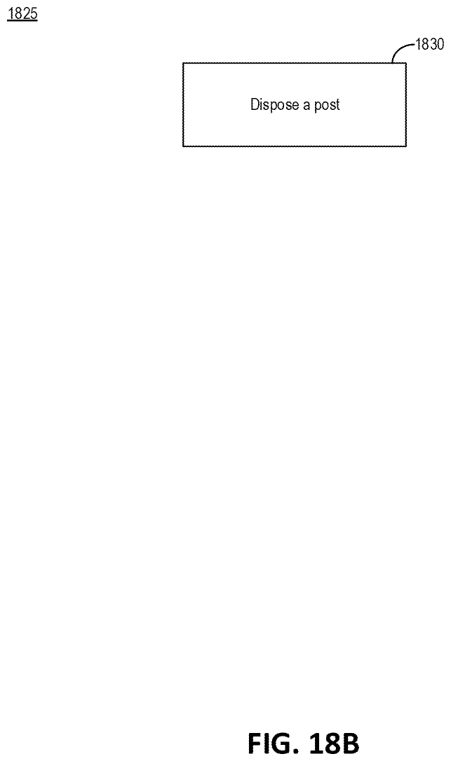

FIG. 18A is a flow diagram of a process 1800 where an apparatus can be provided, in accordance with an implementation. One or more acts of the process 1800 can be performed by one or more components depicts in FIG. 16, including, for example, the data processing system 1605. In ACT 1805 an apparatus can be provided. For example, the apparatus can be the apparatus 605. The apparatus 605 can be provided to a vehicle (e.g., the vehicle 105). The apparatus 605 can be provided during the manufacturing process of the vehicle 105. The apparatus 605 can be provided after the vehicle 105 has been purchased. For example, the apparatus 605 can be provided after the owner of the vehicle 105 purchases the apparatus 605 and the owner then takes the vehicle 105 to a shop that can then provide the apparatus 605. The owner of the vehicle 105 can provide the apparatus 605 on their own. For example, the owner of the vehicle 105 can provide the apparatus 605 upon purchasing the apparatus 605. The apparatus 605 can include a lift device (e.g., the lift device 610). The lift device 610 can include the arm 615 and the post 625.

In ACT 1810, an arm can be adjusted. For example, the arm 615 can be adjusted from a first length to a second length. The data processing system 1605 can adjust the arm 615. For example, the monitor component 1610 can determine that an operator of the apparatus 605 or the vehicle 105 has selected an icon, on the user device 1635 or the interface 1615, to adjust the length of the arm 615. The interface 1615 can provide to, the controller 1620, an indication that the operator selected an icon to adjust the length of the arm 615. The controller 1620, responsive to determining that the indication from the interface 1615 was received, can provide, to the hinge 620, a signal to adjust the arm 615 from the first length to the second length. The arm 615 can also be adjusted by an operator of the vehicle 105 or the apparatus 605 using a piston, spring or hydraulic that is associated with the hinge 620 to then adjust the arm 615 from the first length to the second length.

In ACT 1815, a device is support. The device can be the lift device 610. The lift device 610 can be support by the post 625. The post 625 can support the lift device 610 responsive to the post 625 being mounted, attached, placed, secured or coupled with the vehicle 105. The post 625 can be coupled with the vehicle 105 responsive to the apparatus 605 being provided to the vehicle 105.

In ACT 1820, the arm can be rotated. The arm 615 can be rotated. For example, the arm 615 can be rotated from a first position that is within the vehicle 105 to a second position that is external to the vehicle 105. The data processing system 1605, an operator of the vehicle 105 or an operator of the apparatus 605 can rotate the arm 615. The monitor component 1610 can determine that an operator has selected an icon to rotate the arm 615. The interface 1615 can provide, to the controller 1620, an indication that operator selected an icon to rotate the arm 615. The controller 1620 can provide, to the post 625, a signal that causes the post 625 to rotate the arm 615.

FIG. 18B is a flow diagram of a method 1825 of manufacturing an apparatus. The apparatus can be the apparatus 605. The apparatus can include the lift device 610 or a component thereof (e.g., the arm 615, the post 625). In ACT 1830, a post can be disposed. The post can be the post 625. The post 625 can be disposed with a vehicle. For example, the post 625 can be disposed within a cargo area or a rear compartment of a vehicle. The post 625 can couple with the vehicle. For example, the vehicle and the post 625 can include apertures or openings, and a fastener can be inserted through the openings. The fastener can couple the post 625 with the vehicle. The post 625 can cause at least a portion of an arm to be disposed external to the vehicle. For example, the post 625 can rotate, pivot, spin, swivel, or otherwise move the arm (e.g., the arm 615) from a position inside the vehicle to a position external to the vehicle.

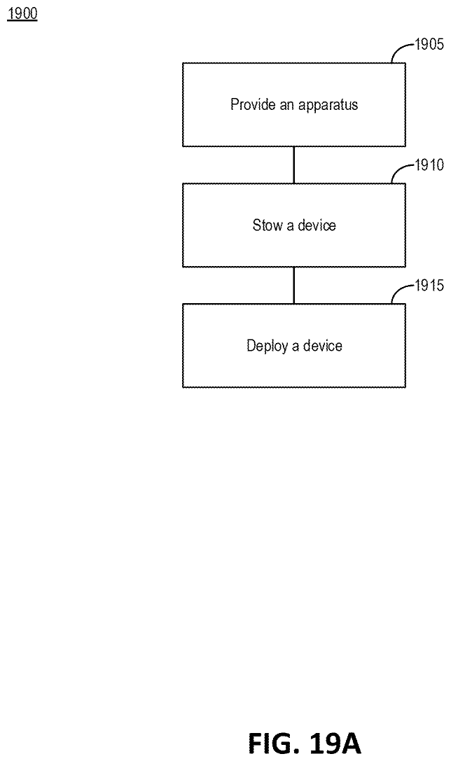

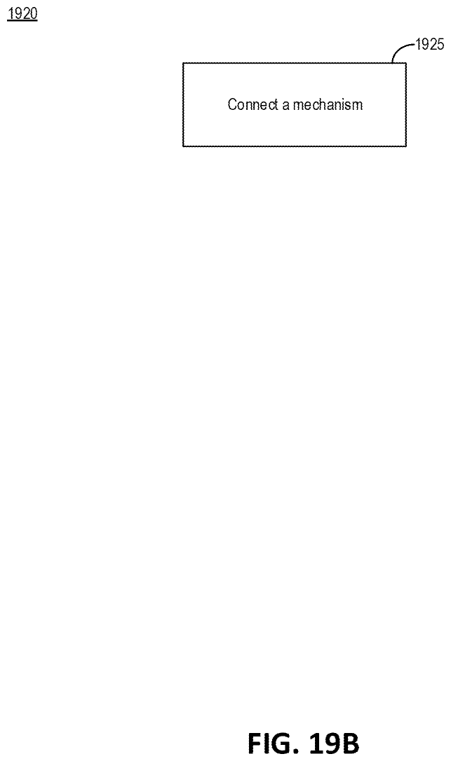

FIG. 19A is flow diagram of a process 1900 where an apparatus can be provided, in accordance with an implementation. One or more of the acts of the process 1900 can be performed by one or more components depicted in FIG. 17, including, for example the data processing system 1605. In ACT 1905 an apparatus can be provided. For example, the apparatus can be the apparatus 1305. The apparatus 1305 can be provided to a vehicle (e.g., the vehicle 105). The apparatus 1305 can be provided during the manufacturing process of the vehicle 105. The apparatus 1305 can be provided after the vehicle 105 has been purchased. For example, the apparatus 1305 can be provided after the owner of the vehicle 105 purchases the apparatus 1305 and the owner then takes the vehicle 105 to a shop that can then provide the apparatus 1305. The owner of the vehicle 105 can provide the apparatus 1305 on their own. For example, the owner of the vehicle 105 can provide the apparatus 1305 upon purchasing the apparatus 1305. The apparatus 1305 can include the mounting module 1310. The mounting module can include the arm 1315 and the pivoting mechanism 1320.

In ACT 1910, a device can be stowed. The device can be stowed by the arm 1315. The arm 1315 can stow the device in a position that is within the vehicle 105. The pivoting mechanism 1320 can enable the arm 1315 to stow the device by allowing the arm 1315 to rotate. The monitor component 1610 can determine that an operator of the apparatus 1305 or the vehicle 105 has selected an icon to stow the device. The interface 1615 can provide, to the controller 1620, an indication that operator has selected the icon to stow the device. The controller 1620, responsive to determining that the indication from the interface 1615 was received, can provide, to the arm 1315, a signal that causes the arm 1315 to stow the device.

In ACT 1915, a device can be deployed. The device can be deployed by the arm 1315. The arm 1315 can deploy the device to a position that is external to the vehicle 105. The pivoting mechanism 1320 can enable the arm 1315 to deploy the device by allowing the arm 1315 to rotate. The monitor component 1610 can determine that an operator of the apparatus 1305 or the vehicle 105 has selected an icon to deploy the device. The interface 1615 can provide, to the controller 1620, an indication that operator has selected the icon to deploy the device. The controller 1620, responsive to determining that the indication was received, can provide, to the arm 1315, a signal that causes the arm 1315 to deploy the device.

FIG. 19B is a flow diagram of a method 1920 of manufacturing an apparatus. The apparatus can be the apparatus 1305. The apparatus can include at least one component of the apparatus 1305 (e.g., the pivoting mechanism 1320, the arm 1315). In ACT 1925 a mechanism can be connected. The mechanism can be the pivoting mechanism 1320. The pivoting mechanism 1320 can be connected to an arm. For example, the pivoting mechanism 1320 can be coupled with the arm 1315. The pivoting mechanism 1320 can couple with a vehicle. For example, the pivoting mechanism 1320 can couple with the vehicle 105. The pivoting mechanism 1320 can move the arm 1315. The pivoting mechanism 1320 can move the arm 1315 to stow a device and to deploy the device. The pivoting mechanism 1320 can move the arm 1315 to stow the device inside the vehicle and the pivoting mechanism 1320 can move the arm 1315 to deploy the device external to the vehicle.

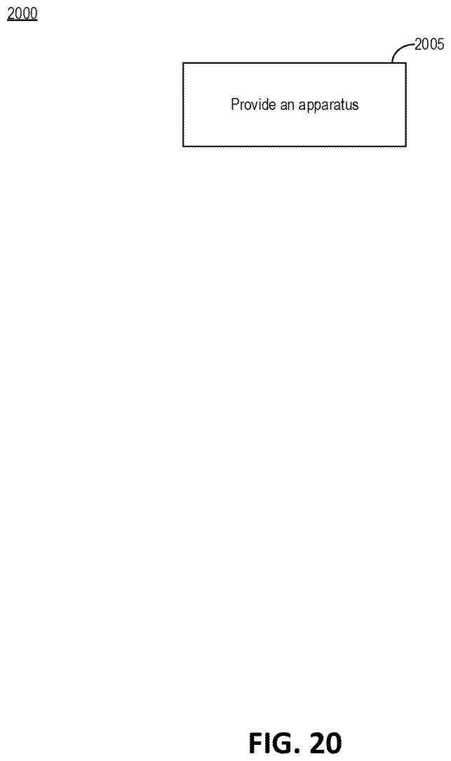

FIG. 20 is a flow diagram of a process 2000 where an apparatus can be provided, in accordance with an implementation. In ACT 2005, an apparatus can be provided. For example, the apparatus can be at least one of the apparatus 205, the apparatus 605, the apparatus 905 or the apparatus 1305. The apparatus can be provided to a vehicle (e.g., the vehicle 105). The apparatus can be provided during the manufacturing process of the vehicle 105. The apparatus can be provided after the vehicle 105 has been purchased. For example, the apparatus can be provided after the owner of the vehicle 105 purchases the apparatus and the owner then takes the vehicle 105 to a shop that can then provide the apparatus. The owner of the vehicle 105 can provide the apparatus on their own. For example, the owner of the vehicle 105 can provide the apparatus upon purchasing the apparatus.

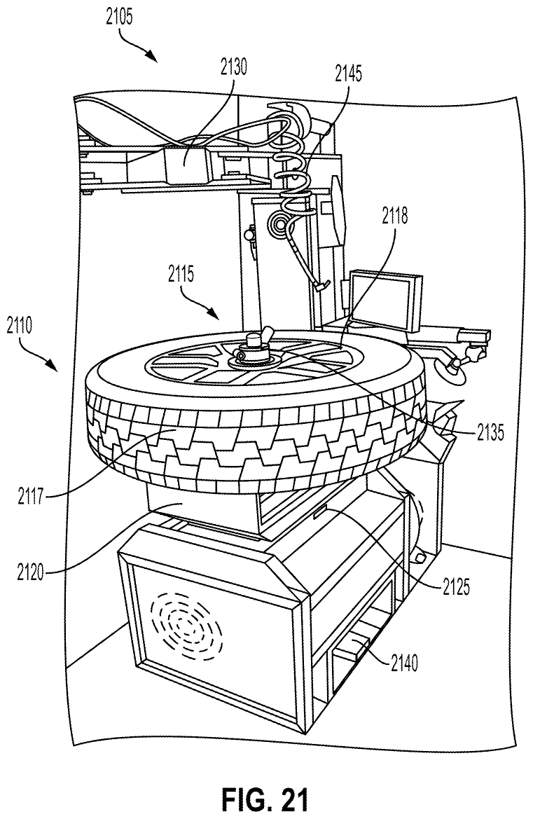

FIG. 21 depicts an apparatus 2105. The apparatus 2105 can be mounted, attached, placed, secured or coupled with a vehicle. For example, the apparatus 2105 can be coupled with the vehicle 105. The apparatus 2105 can be decoupled from the vehicle 105, moved to a different location of the vehicle 105 or the apparatus 2105 can be removed from the vehicle 105. The coupling and decoupling of the apparatus 2105 provides for the ability to adjust, modify, or otherwise change the configuration of the components located in the vehicle 105 while also maximizing the amount of area of the vehicle 105. The apparatus 2105 can include at least one changing module 2110. The changing module 2110 can be or include a tire changer, a tire changing device, a tire replacement device, a tire support device or a tire storage device. The changing module 2110 can include at least one holding module 2120, at least one adjusting module 2125, at least one separating module 2130, at least one locking mechanism 2135, at least one pedal 2140 and at least one hose 2145. The changing module 2110 or a component thereof can receive power from a power source. For example, the battery pack 110 can provide power to the changing module 2110.

The changing module 2110 can receive at least one wheel 2115. For example, the changing module 2110 can receive the wheel 2115 from the lift device 610. The changing module 2110 can also receive the wheel 2115 from an operator of the vehicle 105. For example, the operator of the vehicle 105 can obtain the wheel 2115 and the operator can bring the wheel 2115 to the changing module 2110. The changing module 2110 can receive the wheel 2115 in response to the operator bringing the wheel 2115 to the changing module 2110. The wheel can include at least one first tire 2117 and at least one rim 2118. The changing module 2110 can receive at least one tire (e.g. a second tire 2117). For example, the changing module 2110 can receive the second tire 2117 that can replace the first tire 2117 that is coupled with the wheel 2115.

The holding module 2120 can be or include at least one of a platform, a stand or a support structure. The holding module 2120 can hold at least one wheel. For example, the holding module 2120 can hold the wheel 2115. The holding module 2120 can hold the wheel 2115 by maintaining a position of the wheel 2115 while the operator of the vehicle 105 or the changing module 2110 interacts with the wheel 2115. FIG. 21 depicts an example of the holding module 2120 holding the wheel 2115.

The adjusting module 2125 can be or include at least one or a slide, a track, a glide or a rail. The adjusting module 2125 can adjust the position of the holding module 2120 while the holding module 2120 is holding a wheel (e.g., the wheel 2115) or the adjusting module 2125 can adjust the position of the holding module 2120 prior to or after the changing module has received the wheel 2115. For example, the adjusting module 2125 can adjust the position of the holding module 2120 to create additional space for the changing module 2110 to receive a wheel.

The separating module 2130 can be or include at least one of a bead breaker, a tire separator, a wheel rotator, a wedge or any other possible device that can be used to separate or couple a tire with a rim. The separating module 2130 can separate the tire 2117 from the wheel 2115 or from the rim 2118. The separating module 2130 can also separate the wheel 2115 or the rim 2118 from the tire 2117. The separating module 2130 can, once the tire 2117 has been removed, mount, attach, place, secure or coupled a tire with the wheel 2115 or the rim 2118. The separating module 2130 can reattach the tire 2117 that was previously separated from the wheel 2115 or the separating module 2130 can attached a new tire (e.g., a second tire 2117) to the wheel 2115.

The locking mechanism 2135 can be at least one of a latch, a clasp, a bolt, a clip or a fastener. The locking mechanism 2135 can lock, hold, maintain or otherwise secure the wheel 2115 with or to the changing module 2110. The locking mechanism 2135 can insert into, make contact with, rest in or otherwise couple with at least a portion of the holding module 2120. FIG. 21 depicts an example of the locking mechanism coupled with a portion of the holding module 2120. The pedals 2140 can be operated by the operator of the vehicle 105 or the apparatus 2105. The pedals 2140 can control, activate, initiate or otherwise command at least one of the components included in the separating module 2130. The hose 2145 can provide at least one of air, hydraulic fluid or power to at least one component of the apparatus 2105 or the changing module 2110. For example, the hose 2145 can provide air to the separating module 2130 and the air can be used to assist in the decoupling of the tire 2117 from the rim 2118.

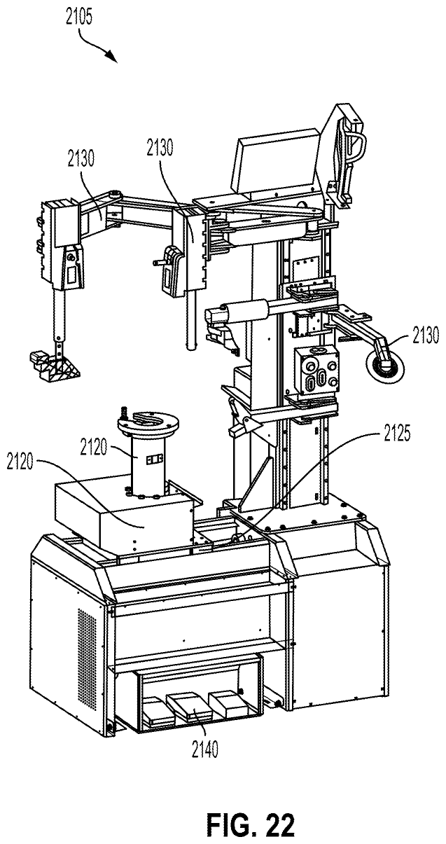

FIG. 22 depicts the apparatus 21105. FIG. 22 depicts an example of the apparatus 2105 not coupled with a vehicle, an example of the changing module 2110 prior to receiving a wheel or after a wheel was provided and a tire was replaced.

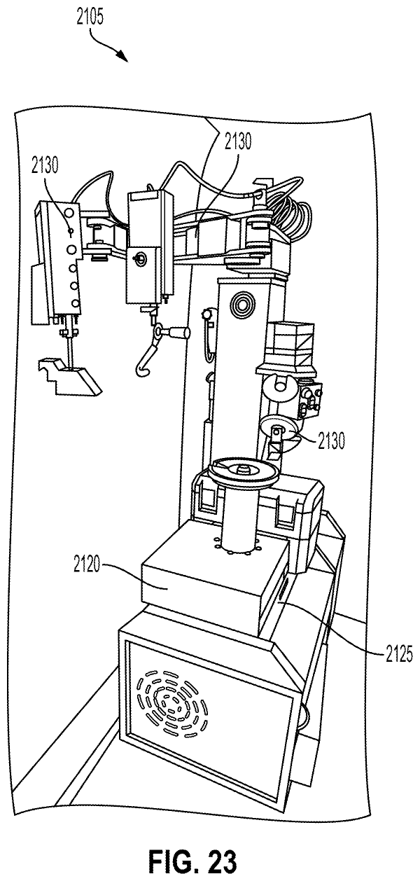

FIG. 23 depicts the apparatus 2105. FIG. 23 depicts an example of the apparatus 2105 coupled with the vehicle 105, an example of the changing module 2110 prior to receiving a wheel or after a wheel was provided and a tire was replaced.

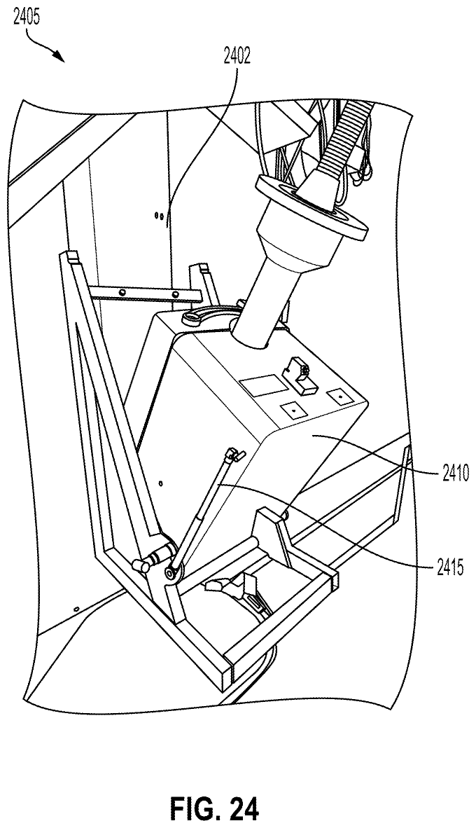

FIG. 24 depicts an apparatus 2405. The apparatus 2405 can be mounted, attached, placed, secured or coupled with a vehicle. For example, the apparatus 2405 can be coupled with the vehicle 105. The apparatus 2405 can be decoupled from the vehicle 105 and moved to a different location of the vehicle 105 or the apparatus 2405 can be removed from the vehicle 105. The apparatus 2405 can be coupled with a structure of the vehicle 105. For example, the apparatus 2405 can be coupled with a wall (e.g., wall 2402) of the vehicle 105. FIG. 24 depicts an example of the apparatus 2405 coupled with the wall 2402 of the vehicle 105. The apparatus 2405 can include at least one balancing module 2410 and at least one adjusting module 2415.

The balancing module 2410 can be or include at least one of a tire balancer, a wheel balancer, a tire equalizer or any other possible device that can balance a wheel. The balancing module 2410 can balance a tire and wheel. For example, the balancing module 2410 can balance the tire 2117 and the wheel 2115. The balancing module 2410 can balance the tire 2117 and the wheel 2115 in response to an operator of the apparatus 2105 or the vehicle 105 replacing a tire that was previously coupled with the wheel 2115. The balancing module 2410 can also balance a tire and a wheel prior to the tire being removed from the wheel. FIG. 24 depicts an example of the apparatus 2405 prior to receiving a wheel or after a wheel has been received and the operator of the apparatus 2405 or the balancing module 2410 has balanced the tire and the wheel.

The adjusting module 2415 can be include at least one of a piston, a hydraulic, a swivel a pivot, a fulcrum or an axle. The adjusting module 2415 can lift, tilt, slant, or otherwise adjust the orientation or configuration of the apparatus 2405 or the balancing module 2410. The adjusting module 2415 can adjust the balancing module 2410 from a first position (e.g., a position where at least a portion of the balancing module 2410 is making contact with the wall 2402) to a second position (e.g., where the balancing module 2410 has been adjusted away from the wall 2402). The adjusting module 2415 can minimize the amount of space that is occupied by the apparatus 2405 or the balancing module 2410 during times of inactivity (e.g., when the apparatus 2405 or the balancing module 2410 is not being used by an operator).

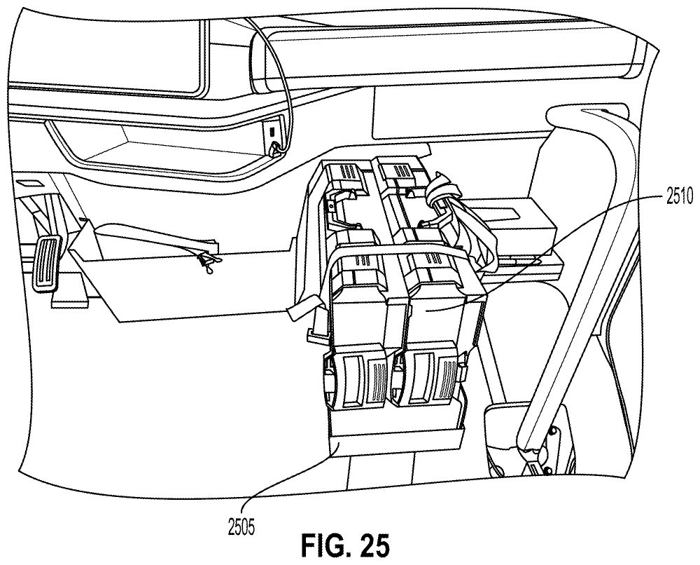

FIG. 25 depicts an example view of the vehicle 105. An apparatus 2505 can be mounted, attached, placed, secured or coupled with the vehicle 105. The apparatus 2505 can be or include a platform, a shelf, a stand, a surface or a compartment. The apparatus 2505 can store, maintain, keep or otherwise hold at least one component. For example, the apparatus 2505 can hold a power tool, a briefcase, a backpack, a banker's box, a bag, a laptop, a container, a storage device or a document holding device. FIG. 25 depicts an example of the apparatus 2505 holding a container 2510, an example of the apparatus 2505 located in an area of the vehicle 105 that can be reached, by the operator of the vehicle 105, while the operator is external to the vehicle 105.

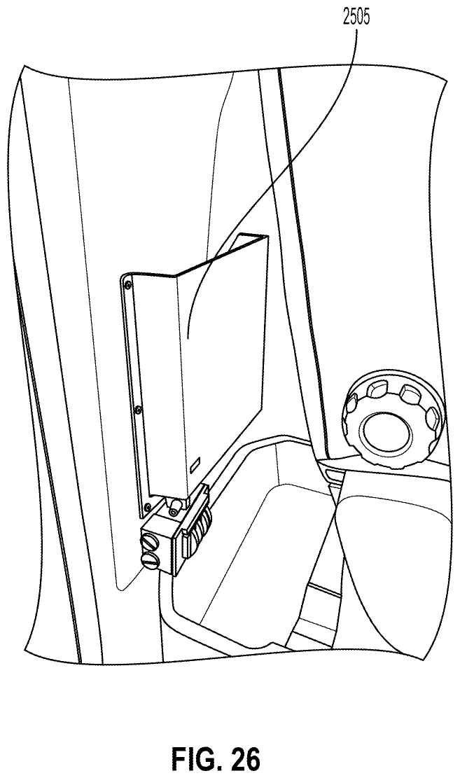

FIG. 26 depicts the apparatus 2505. FIG. 26 depicts an example of the apparatus 2505 coupled with a wall 2605. The apparatus 2505 is located in a location that the operator of the vehicle 105 can reach while seating in driver's seat of the vehicle 105.

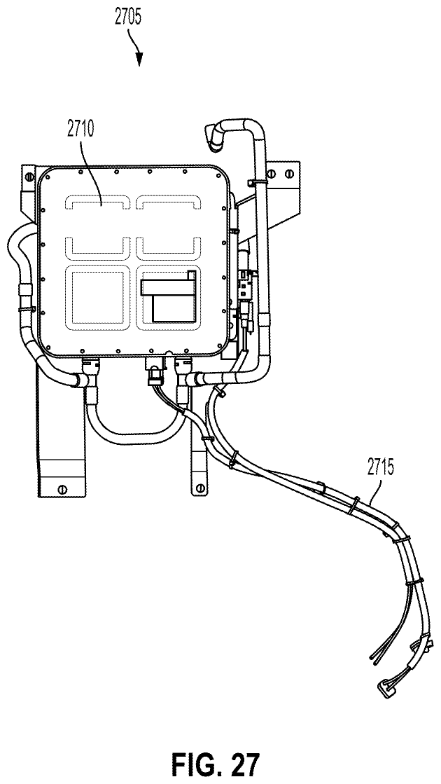

FIG. 27 depicts an apparatus 2705. The apparatus 2705 can include at least one inverter 2710. The inverter 2710 can receive power from a power source. For example, the inverter 2710 can receive power from the battery pack 110. The inverter 2710 can receive Direct Current (DC) from the power source and the inverter 2710 can switch, change, adjust or otherwise invert the DC to Alternating Current (AC). For example, the inverter 2710 can be a 6 kilowatt DC to AC inverter and the inverter 2710 can provide 2 phase 120 V AC or 240V AC. The inverter 2710 can include at least one cord 2715. The cord 2715 can be electrically coupled with at least one device. The inverter 2710 can provide (via the cords 2715) the AC to at least one component or device. For example, the inverter 2710 can provide AC to the lift device 610, a component stored on the shelving module 210, the changing module 2110, the balancing module 2410, a component stored on the apparatus 2505 or a component that is external the vehicle 105. The inverter 2710 can also be used to charge one or more additional vehicles. For example, the inverter 2710 can charge a second vehicle 105. The inverter 2710 can also interact with a Controller Area Network associated with the vehicle 105 or a component thereof. The inverter 2710 can also interact with, communicate with or otherwise interface with the data processing system 1605 or a component thereof.

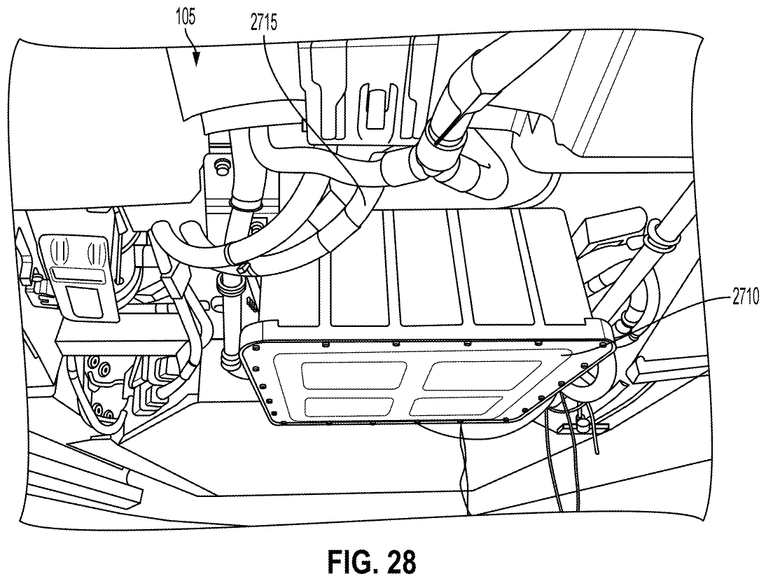

FIG. 28 depicts an example view of the vehicle 105. FIG. 28 depicts an example of the apparatus 2705 coupled with the undercarriage of the vehicle 105. The apparatus 2705 can be positioned in a location of the undercarriage that minimizes the length of the cord 2715. The apparatus 2705 can be positioned in a location of the undercarriages that minimizes the distance between the apparatus 2705 and the battery pack 110.

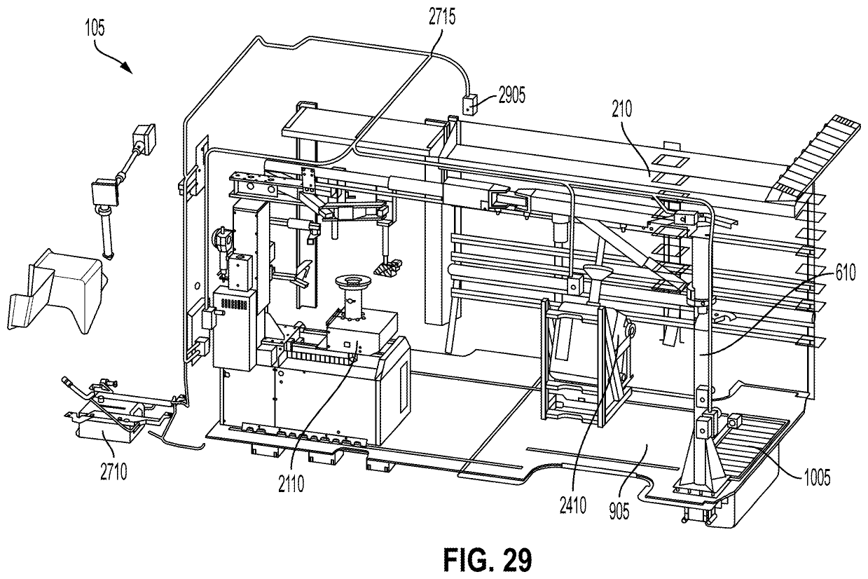

FIG. 29 depicts an example view of the vehicle 105. FIG. 29 depicts an example of the shelving module 210, the lift device 610, the apparatus 905, the changing module 2110 and the balancing module 2410 coupled with the vehicle 105, an example of the inverter 2710 electrically coupled with the lift device 610, the changing module 2110 and the balancing module 2410. FIG. 29 also depicts the inverter 2710 providing power to an outlet 2905.

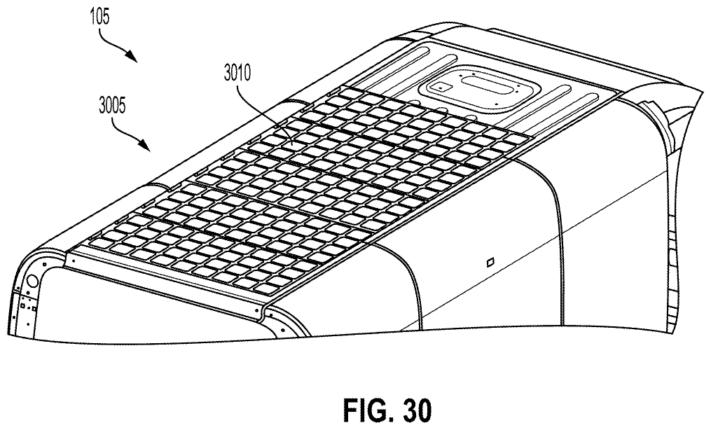

FIG. 30 depicts an example view of the vehicle 105. An apparatus 3005 can be mounted, attached, placed, secured or coupled with the vehicle 105. FIG. 30 depicts an example of the apparatus 3005 coupled with the roof of the vehicle 105. The apparatus 3005 can include at least one collecting module 3010. The collecting module 3010 can include at least one of at least one solar panel, at least one photovoltaic cell, a power storage device or a power transfer device. The collecting module 3010 can collect energy or power from a source. For example, the collecting module 3010 can collect energy from the sun. The collecting module 3010 can be electrically coupled with the battery pack 110 and the collecting module 3010 can provide power to the battery pack 110. The collecting module 3010 can also be electrically coupled with and provide power to at least one of the lift device 610, the changing module 2110, the balancing module 2410 or the outlet 2905.

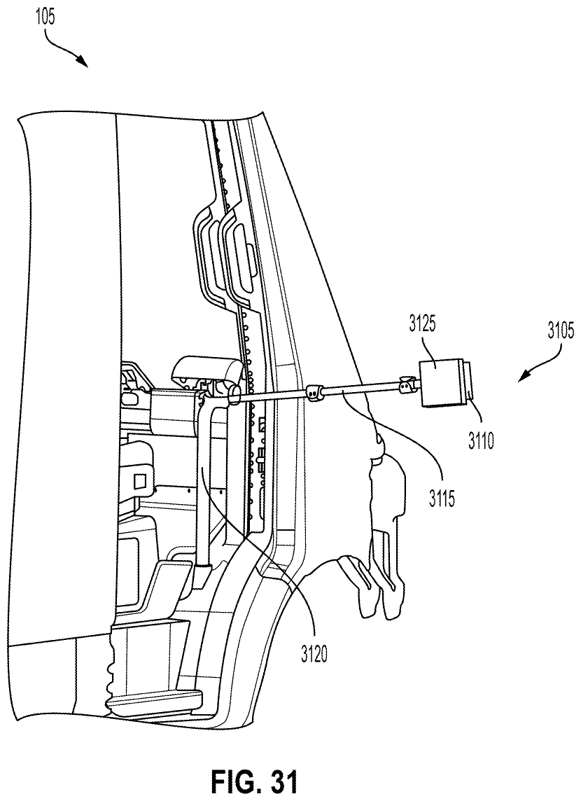

FIG. 31 depicts an example view of the vehicle 105. An apparatus 3105 can be mounted, attached, placed, secured or coupled with the vehicle 105. FIG. 31 depicts an example of the apparatus 3105 coupled to an internal area of the vehicle 105. The apparatus 3105 can include at least one light fixture 3110, at least one adjusting module 3115 and at least one post 3120. The light fixture 3110 can include at least one light source 3125. The light source 3125 can produce light. For example, the light source 3125 can produce at least one photon. The light source 3125 can be or include at least one of at least one Light Emitting Diode (LED), an incandescent light, a halogen light or a fluorescent light. The adjusting module 3115 can adjust at least one of the location of the light fixture 3110, the orientation of the light fixture 3110, the distance between the post 3120 and the light source 3125 or the direction that the light fixture 3110 is facing (e.g., facing towards a ground surface, facing towards the sky, facing towards a certain object, facing towards the vehicle).

The adjusting module 3115 can have at least one length and the length can be adjusted (e.g., increase or decrease). An operator of the apparatus 3105 can adjust the length of the adjusting module 3115 by interacting with, engaging with or otherwise interface with at least a portion of the adjusting module 3115 that can be adjusted. The adjusting module 3115 can include a swivel that can be rotated by the operator and once the swivel is rotated the operator can extend or contract at least a portion of the adjusting module 3115. The extending or contracting of the adjusting module 3115 can adjust the distance between the light fixture 3110 and the vehicle 105. The adjusting module 3115 can include a hinge that can adjust the angle or the orientation of the light fixture 3110. The post 3120 can be coupled with at least a portion of the vehicle 105 and the post can support the adjusting module 3115 or the light fixture 3110.

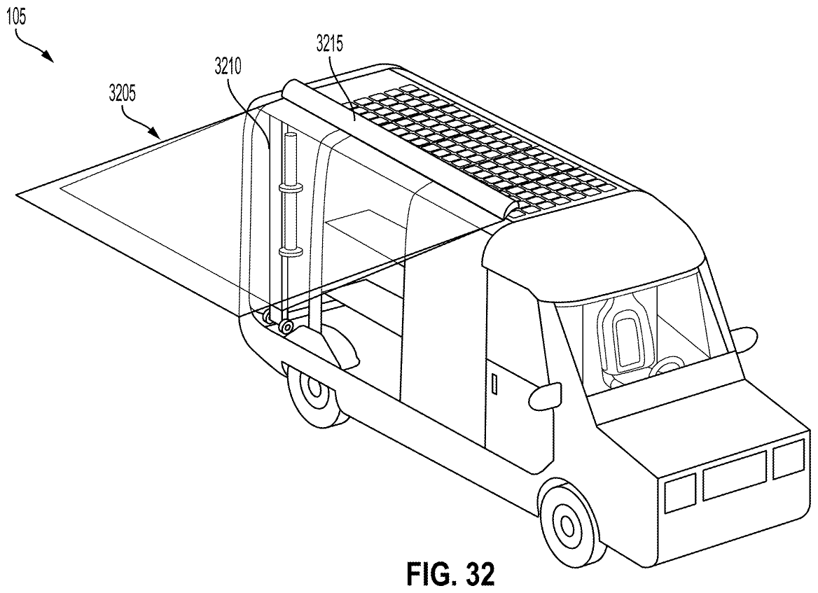

FIG. 32 depicts an example view of the vehicle 105. An apparatus 3205 can be mounted, attached, placed, secured or coupled with the vehicle 105. The apparatus 3205 can include at least one covering module 3210 and at least one storage compartment 3215. The covering module 3210 can be or include at least one of a canopy, a shade, a sunshade, a cover, a blind or an awning. The covering module 3210 can provide shade to an area on or around the vehicle 105. The covering module 3210 can block, obstruct or otherwise prevent light from hitting the area that is shaded by the covering module 3210. The covering module 3210 can have at least one stowed position and at least one deployed position. The storage compartment 3215 can hold, maintain, keep or otherwise store at least a portion of the covering module. For example, the covering module 3210 can retract from or retract into the storage compartment 3215. The stowed position can be at least one of a position that is within the vehicle 105 or a position where at least a portion of the covering module 3210 is retracted into or within the storage compartment 3215. The deployed position can be at least one of a position that is external to the vehicle 105 or a position where at least a portion of the covering module is extended out of the storage compartment 3215.

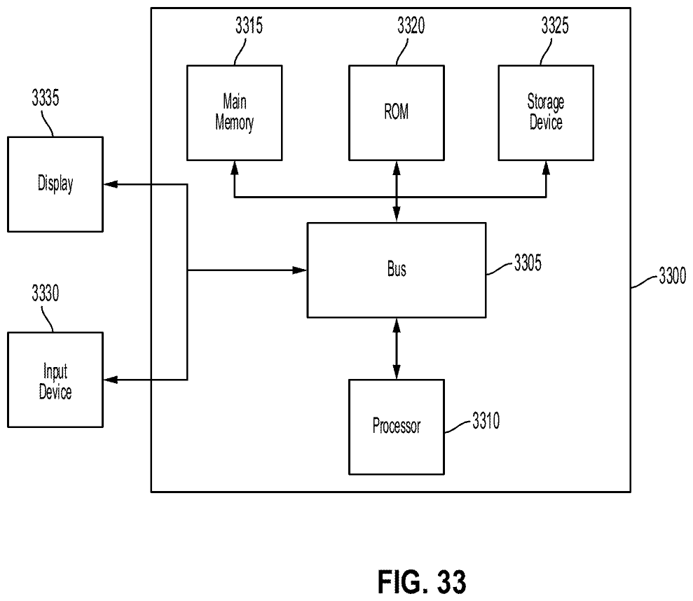

FIG. 33 depicts an example block diagram of an example computer system 3300. The computer system or computing device 3300 can include or be used to implement a data processing system or its components. The computing system 3300 includes at least one bus 3305 or other communication component for communicating information and at least one processor 3310 or processing circuit coupled to the bus 3305 for processing information. The computing system 3300 can also include one or more processors 3310 or processing circuits coupled to the bus for processing information. The computing system 3300 also includes at least one main memory 3315, such as a random access memory (RAM) or other dynamic storage device, coupled to the bus 3305 for storing information, and instructions to be executed by the processor 3310. The main memory 3315 can be used for storing information during execution of instructions by the processor 3310. The computing system 3300 may further include at least one read only memory (ROM) 3320 or other static storage device coupled to the bus 3305 for storing static information and instructions for the processor 3310. A storage device 3325, such as a solid state device, magnetic disk or optical disk, can be coupled to the bus 3305 to persistently store information and instructions.

The computing system 3300 may be coupled via the bus 3305 to a display 3335, such as a liquid crystal display, or active matrix display, for displaying information to a user such as a driver of the electric vehicle 105 or other end user. An input device 3330, such as a keyboard or voice interface may be coupled to the bus 3305 for communicating information and commands to the processor 3310. The input device 3330 can include a touch screen display 3335. The input device 3330 can also include a cursor control, such as a mouse, a trackball, or cursor direction keys, for communicating direction information and command selections to the processor 3310 and for controlling cursor movement on the display 3335.

The processes, systems and methods described herein can be implemented by the computing system 3300 in response to the processor 3310 executing an arrangement of instructions contained in main memory 3315. Such instructions can be read into main memory 3315 from another computer-readable medium, such as the storage device 3325. Execution of the arrangement of instructions contained in main memory 3315 causes the computing system 3300 to perform the illustrative processes described herein. One or more processors in a multi-processing arrangement may also be employed to execute the instructions contained in main memory 3315. Hard-wired circuitry can be used in place of or in combination with software instructions together with the systems and methods described herein. Systems and methods described herein are not limited to any specific combination of hardware circuitry and software.

Although an example computing system has been described in FIG. 33, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a post configured to couple with an electric vehicle; and
the post configured to cause at least a portion of an arm to be disposed external to the electric vehicle.

2. The apparatus of claim 1, comprising:
the arm configured to move from a position inside the electric vehicle to a position external to the electric vehicle.

3. The apparatus of claim 1, comprising:
the post configured to move the arm from a first position to a second position, wherein the first position is inside the electric vehicle and the second position is external to the electric vehicle.

4. The apparatus of claim 1, comprising:
a stopping mechanism configured to prevent the post from moving the arm beyond a predetermined position;
a grabbing mechanism coupled with the arm, the grabbing mechanism configured to couple with an object, wherein the grabbing mechanism includes a cable; and
a motor coupled with the grabbing mechanism, the motor configured to adjust the grabbing mechanism from a first height to a second height.

5. The apparatus of claim 1, comprising:
the arm configured to adjust from a first length to a second length and at least one of the first length or the second length is different than a length of the post.

6. The apparatus of claim 1, comprising:
a locking mechanism configured to lock the arm in at least one of a first position or a second position; and
a power source configured to provide power to at least one of the arm or the post.

7. The apparatus of claim 1, comprising:
a data processing system, the data processing system comprising at least one processor, coupled with memory, to:
determine, via a graphical user interface, an indication to move the arm from a first position to a second position; and
move, responsive to the indication, the arm from the first position to the second position.

8. The apparatus of claim 1, comprising:
a data processing system, the data processing system comprising at least one processor, coupled with memory, to:
determine, via a graphical user interface, an indication to adjust the arm from a first length to a second length; and
adjust, responsive to the indication, the arm from the first length to the second length.

9. The apparatus of claim 1, wherein:
the post comprises:
a motor configured to receive power from a battery of the electric vehicle, and the motor configured to move the arm from a first position to a second position; and
the battery configured to provide power to move the electric vehicle.

10. The apparatus of claim 1, comprising:
the post configured to receive power from a battery of the electric vehicle via an inverter, and the post configured to, responsive to receipt of the power, move the arm from a first position to a second position; and
the battery configured to provide power to move the electric vehicle.

11. A method, comprising:
disposing a post within an electric vehicle, the post configured to couple with the electric vehicle, and the post configured to cause at least a portion of an arm to be disposed external to the electric vehicle.

12. The method of claim 11, wherein the arm is configured to move from a position inside the electric vehicle to a position external to the electric vehicle.

13. The method of claim 11, wherein the post is configured to move the arm from a first position to a second position, wherein the first position is inside the electric vehicle and the second position is external to the electric vehicle.

14. The method of claim 11, comprising:
disposing a stopping mechanism on the post, the stopping mechanism configured to prevent the post from moving the arm beyond a predetermined position;
coupling a grabbing mechanism with the arm, the grabbing mechanism configured to couple with an object, wherein the grabbing mechanism includes a cable; and
coupling a motor with the grabbing mechanism, the motor configured to adjust the grabbing mechanism from a first height to a second height.

15. The method of claim 11, wherein the arm is configured to adjust from a first length to a second length and at least one of the first length or the second length is different than a length of the post.

16. The method of claim 11, comprising:
coupling a locking mechanism with the arm, the locking mechanism configured to lock the arm in at least one of a first position or a second position; and
electrically coupling a power source with at least one of the arm or the post, the power source configured to provide power to at least one of the arm or the post.

17. The method of claim 11, comprising:
connecting a motor with the post;
the motor configured to receive power for a battery of the electric vehicle, and the motor configured to move the arm from a first position to a second position; and
the battery of the electric vehicle configured to provide power to move the electric vehicle.

18. An electric vehicle, comprising:
an apparatus, including:
a post coupled with the electric vehicle; and
the post configured to cause at least a portion of an arm to be disposed external to the electric vehicle.

19. The electric vehicle of claim 18, wherein the post is configured to move the arm from a first position to a second position, wherein the first position is inside the electric vehicle and the second position is external to the electric vehicle.

20. The electric vehicle of claim 18, wherein:
the apparatus comprises:
a stopping mechanism configured to prevent the post from moving the arm beyond a predetermined position;
a grabbing mechanism coupled with the arm, the grabbing mechanism configured to couple with an object, wherein the grabbing mechanism includes a cable; and
a motor coupled with the grabbing mechanism, the motor configured to adjust the grabbing mechanism from a first height to a second height.
